(19) United States
(12) Patent Application Publication
(10) Pub. No.: US 2026/0332956 A1
(43) Pub. Date: Oct. 22, 2026

(54) SOUND-GENERATING DEVICE, SOUND-GENERATING MODULE, AND ELECTRONIC DEVICE

(71) Applicant: GOERTEK INC., Weifang (CN)

(72) Inventors: Xiaodong CAI, Weifang (CN); Linlin ZHANG, Weifang (CN)

(21) Appl. No.: 19/727,941

(22) Filed: Jul. 1, 2026

Related U.S. Application Data
(63) Continuation of application No. PCT/CN2025/105521, filed on Jun. 30, 2025.

(30) Foreign Application Priority Data
Jan. 2, 2025 (CN) 202520006058.0

(51) Int. Cl. H04R 7/04; H04R 1/02; H04R 7/18; H04R 9/02; H04R 9/04; H04R 9/06

(52) U.S. Cl. CPC H04R 7/04; H04R 1/025; H04R 7/18; H04R 9/025; H04R 9/045; H04R 9/06

(57) ABSTRACT

The present application provides a sound-generating device, a sound-generating module and an electronic device; the central magnetic portion in the magnetic circuit system of the sound-generating device includes a first central magnet, a central magnetic conductive plate, and a second central magnet distributed in a stacked manner; an inner side of the inner folded ring of the first diaphragm in the vibration system is connected to the central magnetic portion; an outer periphery of the outer folded ring is connected to the housing; the diaphragm and the second diaphragm assembly are sequentially provided at a side of the first diaphragm assembly facing the magnetic conductive yoke; an outer edge of the diaphragm is connected to the housing, and an outer edge of the second diaphragm assembly is connected to the housing; an inner edge of the diaphragm is connected to an inner edge of the second diaphragm assembly.

### CROSS-REFERENCE TO RELATED APPLICATIONS

This application is a continuation application of International Application No. PCT/CN2025/105521, filed on Jun. 30, 2025, which claims priority to Chinese Patent Application No. 202520006058.0, filed on Jan. 2, 2025, the entire contents of which are incorporated herein by reference.

### TECHNICAL FIELD

The present application relates to the technical field of electroacoustic transduction, and in particular to a sound-generating device, a sound-generating module and an electronic device using the sound-generating device.

### BACKGROUND

In recent years, with the rapid development of consumer electronics, people’s demands for electronic products have been continuously increasing, such as portability and comfort. Sound-generating devices are important electroacoustic transducers in consumer electronics, widely used as speakers, earpieces, and headphones. With the improvement of electronic product performance, the improvement of the acoustic performance of sound-generating devices is an inevitable trend.

For sound-generating devices, the magnetic circuit system is used to drive the diaphragm in the vibration system to vibrate, repeatedly pushing air to generate sound. The diaphragm, as the core component of the sound-generating device, directly affects the acoustic performance. Among these factors, the effective vibration area (Sd) of the diaphragm is one of the most important factors affecting the acoustic performance of the sound-generating device; the larger the effective vibration area of the diaphragm, the better the acoustic performance of the sound-generating device. However, the effective vibration area of the diaphragm of the sound-generating device in the related art is small, which affects the acoustic performance of the sound-generating device.

### SUMMARY

The main purpose of the present application is to provide a sound-generating device, a sound-generating module, and an electronic device, aiming to provide a sound-generating device with the increased effective vibration area. Compared with conventional loudspeakers, this sound-generating device increases the effective vibration area under the same amplitude conditions, thereby improving the performance of the sound-generating device, and achieving a thinner and lighter product size under the same performance conditions.

To achieve above objectives, the present application provides a sound-generating device, including:
a housing, provided with a sound hole;
a magnetic circuit system, connected to the housing, where the magnetic circuit system includes a magnetic conductive yoke, a central magnetic portion, and a side magnetic portion; the central magnetic portion and the side magnetic portion are provided at the magnetic conductive yoke; the side magnetic portion is provided outside the central magnetic portion and forms a magnetic gap with the central magnetic portion; the central magnetic portion includes a first central magnet, a central magnetic conductive plate, and a second central magnet distributed in a stacked manner; the first central magnet is connected to the magnetic conductive yoke; and
the vibration system, including a first diaphragm assembly, a second diaphragm assembly, a voice coil, a diaphragm, and a rigid connector; where the first diaphragm assembly includes an inner folded ring, a first vibration plate, and an outer folded ring connected in sequence; an inner side of the inner folded ring is connected to a second central magnet; an outer periphery of the outer folded ring is connected to the housing; an end of the voice coil is connected to the first diaphragm assembly; the other end of the voice coil is suspended in the magnetic gap; the diaphragm and the second diaphragm assembly are sequentially provided at a side of the first diaphragm assembly facing the magnetic conductive yoke, and are provided outside the voice coil; an outer edge of the diaphragm is connected to the housing, and an outer edge of the second diaphragm assembly is connected to the housing; an inner edge of the diaphragm is connected to an inner edge of the second diaphragm assembly to form a sound-generating cavity communicating with the sound hole between the diaphragm and the second diaphragm assembly; an end of the rigid connector is connected to the second diaphragm assembly; the other end of the rigid connector is connected to the voice coil, to make the voice coil drive the second diaphragm assembly to vibrate through the rigid connector; both the first central magnet and the second central magnet are magnetized along a vibration direction of a vibration system, and a magnetization direction of the first central magnet is opposite to a magnetization direction of the second central magnet.

In an embodiment, the second diaphragm assembly includes a folded ring portion and a second vibration plate; an outer periphery of the folded ring portion is connected to the housing; the second vibration plate includes a main body portion connected to an inner edge of the folded ring portion and a first bending portion; the first bending portion is formed by the main body portion bending and extending toward the diaphragm; the first bending portion is connected to the inner edge of the diaphragm.

In an embodiment, an inclined portion is formed at a joint between the main body portion and the first bending portion; an angle is formed between the inclined portion and the vibration direction of the vibration system; and/or the outer periphery of the folded ring portion is bent to form a first flange; the first flange is connected to an outer wall of the housing.

In an embodiment, a plurality of side magnetic portions are provided; an avoidance space is formed between two adjacent side magnetic portions; the second vibration plate is provided with a first extension portion extending to the avoidance space; the diaphragm is provided with a second extension portion extending to the avoidance space; the second extension portion is connected to the first extension portion; or a plurality of side magnetic portions are provided; an avoidance space is formed between two adjacent side magnetic portions; the voice coil is provided with a first protrusion portion extending to the avoidance space; the central magnetic portion is provided with a second protrusion portion extending into the avoidance space; the first protrusion portion is disposed opposite to the second protrusion portion.

In an embodiment, the diaphragm is a flexible component; the diaphragm includes an outer connecting portion, a deformable portion, and an inner connecting portion connected in sequence; an outer periphery of the outer connecting portion is connected to the housing; an inner edge of the inner connecting portion is connected to the first bending portion, and the deformable portion is in a bent shape.

In an embodiment, the inner edge of the inner connecting portion is configured to bend and extend toward the first bending portion to form a second flange, and the second flange is connected to the first bending portion; and/or along the vibration direction of the vibration system, a projection width L1 of the deformable portion is greater than or equal to a projection width L2 of the folded ring portion, and a ratio of L1 to L2 is ranged from 1:1 to 3:1; and/or the deformable portion is configured to protrude toward a direction away from the first diaphragm assembly; the folded ring portion is configured to protrude toward a direction close to the first diaphragm assembly; the deformable portion and the folded ring portion are staggered along a direction perpendicular to the vibration system; and/or both the inner folded ring and the outer folded ring are configured to protrude along a direction away from the magnetic circuit system; and/or a compliance of the diaphragm is greater than a compliance of the folded ring portion.

In an embodiment, an effective vibration area Sd1 of the diaphragm is smaller than an effective vibration area Sd2 of the second diaphragm assembly, and a ratio of Sd1 to Sd2 is ranged form 1:1.5 to 1:3.

In an embodiment, the first vibration plate is configured to bend and extend toward the voice coil to form a second bending portion; the second bending portion is connected to the voice coil; or the first diaphragm assembly further includes a bracket; an end of the bracket is connected to the first vibration plate, and the other end of the bracket is connected to the voice coil; and/or the outer periphery of the outer folded ring is configured to bend and extend to form a third flange; the third flange is connected to an outer wall of the housing.

In an embodiment, the vibration system further includes a centering sheet; the centering sheet includes an outer fixing portion, an inner fixing portion, and a vibration arm connecting the outer fixing portion and the inner fixing portion; the outer fixing portion is connected to the housing, and the rigid connector is provided at the inner fixing portion; the second diaphragm assembly includes a folded ring portion and a second vibration plate connected to the folded ring portion; an outer periphery of the folded ring portion is connected to the housing; an inner edge of the second vibration plate is connected to an inner edge of diaphragm; and the inner fixing portion is connected to the second vibration plate and the voice coil, and is electrically connected to a lead wire of the voice coil.

In an embodiment, the inner fixing portion includes a body portion and a third extension portion extending from the body portion toward the voice coil; the body portion is connected to the second vibration plate, and the third extension portion is connected to the voice coil; the third extension portion or the body portion is provided with an inner bonding pad electrically connected to the lead wire of the voice coil.

In an embodiment, the magnetic conductive yoke is provided with an avoidance structure corresponding to the inner fixing portion; the avoidance structure is a recessed groove or a through hole; and/or the rigid connector includes a rigid connecting portion and a fourth extension portion extending from the rigid connecting portion toward the voice coil; the rigid connecting portion is connected to the body portion, and the fourth extension portion is connected to the third extension portion; and/or the rigid connector is provided at a side of the inner fixing portion away from the second diaphragm assembly; and/or the outer fixing portion is arranged in an annular shape; the outer fixing portion is provided with a short axis side and a long axis side connected to the short axis side in a staggered manner; the vibration arm is led out from a side of the inner fixing portion corresponding to the short axis side and extends along the long axis side after being bent; the vibration arm is connected to a central region of the long axis side; and/or the centering sheet further includes a conductive portion; one end of the conductive portion is connected to the outer fixing portion; the other end of the conductive portion is configured to extend along a direction away from the housing and is provided with an external bonding pad.

In an embodiment, the housing includes a first housing and a second housing; the first housing is provided with the sound hole; both the outer periphery of the outer folded ring and an outer periphery of the diaphragm are connected to the first housing; the magnetic conductive yoke is connected to the second housing; an outer periphery of the second diaphragm assembly is clamped between the first housing and the second housing.

In an embodiment, the first housing is provided with a sidewall and an inner bending portion; an end of the sidewall away from the second housing is configured to bend and extend inward to form the inner bending portion; both the outer folded ring and the outer periphery of the diaphragm are connected to the inner bending portion; the outer periphery of the second diaphragm assembly is clamped between an end of the sidewall away from the inner bending portion and the second housing; the sound hole is provided at the sidewall or the inner bending portion.

In an embodiment, the inner bending portion includes an upper surface, a lower surface, and an inner surface; the upper surface and the lower surface are disposed opposite to each other; the inner surface is configured to connect the upper surface and the lower surface, and the inner surface is provided at an end of the inner bending portion away from the sidewall; and the outer periphery of the outer folded ring is connected to the upper surface, and the outer periphery of the diaphragm is connected to the lower surface; or, the outer periphery of the outer folded ring is connected to the upper surface, and the outer periphery of the diaphragm is clamped between the outer periphery of the outer folded ring and the upper surface.

In an embodiment, the first housing is a metal housing, and the second housing is a metal housing; the first housing is provided with a welding portion extending toward the magnetic conductive yoke, and the welding portion is welded to the magnetic conductive yoke or the second housing; and/or, the magnetic conductive yoke or the second housing is provided with a welding portion extending toward the first housing, and the welding portion is welded to an outer wall of the first housing; and/or, the sound-generating device further includes a metal welding sheet, one end of the metal welding sheet being connected to the magnetic conductive yoke or the second housing; the other end of the metal welding sheet being welded to an outer wall of the first housing; and/or the second housing and the magnetic conductive yoke are integrally formed; and/or the vibration system further includes a centering sheet; the centering sheet includes an outer fixing portion, an inner fixing portion, and a vibration arm connecting the outer fixing portion and the inner fixing portion; the outer fixing portion is clamped between the second housing and the outer periphery of the second diaphragm assembly; the rigid connector is provided at the inner fixing portion; the inner fixing portion is connected to the voice coil and electrically connected to a lead wire of the voice coil.

In an embodiment, the side magnetic portion includes a side magnet and a side magnetic conductive plate stacked together; the side magnet is connected to the magnetic conductive yoke; the side magnetic conductive plate is disposed opposite to the central magnetic conductive plate; a magnetization direction of the side magnet is opposite to a magnetization direction of the first central magnet.

The present application further provides a sound-generating module, including: a module housing provided with a mounting cavity and a sound outlet communicating with the mounting cavity; and the sound-generating device as mentioned above. The sound-generating device is provided in the mounting cavity; a front acoustic cavity is formed between the first diaphragm assembly of the sound-generating device and the module housing; the front acoustic cavity communicates with the sound outlet; and the sound-generating cavity of the sound-generating device communicates with the sound outlet through the front acoustic cavity; or, the module housing is further provided with a sound channel, and the sound-generating cavity of the sound-generating device communicates with the sound outlet through the sound outlet channel; or, the sound outlet of the sound-generating device is directly opposite to and communicates with the sound outlet.

The present application further provides an electronic device including: the sound-generating device as mentioned above, or the sound-generating module as mentioned above.

The sound-generating device of the present application holds a magnetic circuit system and a vibration system within a housing. The magnetic circuit system includes a magnetic conductive yoke, a central magnetic portion, and a side magnetic portion; the central magnetic portion and the side magnetic portion are provided at the magnetic conductive yoke. The side magnetic portion is provided outside the central magnetic portion and forms a magnetic gap with the central magnetic portion. The vibration system includes the first diaphragm assembly, the second diaphragm assembly, the voice coil, the diaphragm, and the rigid connector. The inner side of the inner folded ring of the first diaphragm assembly is connected to the central magnetic portion, and the outer periphery of the outer folded ring is connected to the housing. One end of the voice coil is connected to the first diaphragm assembly, and the other end of the voice coil is suspended in the magnetic gap. When current passes through the voice coil, electrical energy can be converted into mechanical energy within the magnetic gap formed within magnetic circuit system, driving the voice coil to make the first diaphragm assembly vibrate, thus generating sound. In addition, the diaphragm and the second diaphragm assembly are sequentially provided at the side of the first diaphragm assembly facing the magnetic conductive yoke, and located outside the voice coil, so that the outer edges of the diaphragm and the second diaphragm assembly are connected to the housing, and the inner edge of the diaphragm is connected to the inner edge of the second diaphragm assembly, forming a sound-generating cavity between the diaphragm and the second diaphragm assembly. A sound hole is provided in the housing, and the sound hole communicates with the sound-generating cavity. One end of the rigid connector is connected to the second diaphragm assembly, and the other end of the rigid connector is connected to the voice coil. In this way, the voice coil can drive the second diaphragm assembly to vibrate through the rigid connector. Thus, by adding a diaphragm and a second diaphragm assembly to a conventional loudspeaker, when the sound-generating device is working, the voice coil drives the second diaphragm assembly to vibrate through the rigid connector. In this case, a volume between the diaphragm and the second diaphragm assembly will change, so that the air in the sound-generating cavity can pass through the sound hole smoothly, which increases the effective vibration area of the sound-generating device, thereby improving performance. Furthermore, by configuring the central magnetic portion as a magnetic-opposite structure, that is, the central magnetic portion includes a first central magnet, a central magnetic conductive plate, and a second central magnet stacked together; the first central magnet and the second central magnet are both magnetized along the vibration direction of the vibration system and the magnetization directions are opposite, so that the magnetic field strength of the magnetic circuit system of the sound-generating device can be increased, thus improving the overall performance of the sound-generating device.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a top view of a schematic structural diagram of a sound-generating device according to an embodiment of the present application.

FIG. 2 is a bottom view of a schematic structural diagram of the sound-generating device according to an embodiment of the present application.

FIG. 3 is an exploded schematic diagram of the sound-generating device according to an embodiment of the present application.

FIG. 4 is a cross-sectional schematic diagram of the sound-generating device according to an embodiment of the present application.

FIG. 5 is a cross-sectional schematic diagram of the sound-generating device according to an embodiment of the present application from another perspective.

FIG. 6 is a structural schematic diagram of the sound-generating device according to another embodiment of the present application.

FIG. 7 is a top view of a partial structural diagram of the sound-generating device according to an embodiment of the present application.

FIG. 8 is a top view of a schematic structural diagram of the sound-generating device according to an embodiment of the present application showing the connection between the magnetic circuit system, the centering sheet, and the rigid connector.

FIG. 9 is an exploded diagram of FIG. 8.

FIG. 10 is a top view of a schematic structural diagram of the sound-generating device according to another embodiment of the present application showing the connection between the magnetic circuit system, the centering sheet, and the rigid connector.

FIG. 11 is an exploded schematic diagram of the centering sheet and the rigid connector according to an embodiment of the present application.

FIG. 12 is a schematic structural diagram of the centering sheet and the rigid connector according to another embodiment of the present application.

FIG. 13 is a schematic structural diagram of the diaphragm according to an embodiment of the present application.

FIG. 14 is a schematic structural diagram of the second vibration plate according to an embodiment of the present application.

FIG. 15 is a schematic structural diagram of the second vibration plate according to another embodiment of the present application.

FIG. 16 is a cross-sectional schematic diagram of the sound-generating module according to an embodiment of the present application.

FIG. 17 is a cross-sectional schematic diagram of the sound-generating module according to an embodiment of the present application from another perspective.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the claimed scope of the present application.

It should be noted that all the directional indications (such as up, down, left, right, front, rear…) in the embodiments of the present application are only used to explain the relative positional relationship, movement, or the like of the components in a certain posture (as shown in the drawings). If the specific posture changes, the directional indication will change accordingly.

In addition, if “and/or” appears throughout the text, it includes three parallel schemes. Taking “A and/or B” as an example, it includes the scheme A, or the scheme B, or the scheme that the scheme A and the scheme B satisfy at the same time.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

In recent years, with the rapid development of consumer electronics, people’s demands for electronic products have been continuously increasing. Besides differences in the product performance, portability and comfort are key concerns. Currently, conventional speaker solutions struggle to simultaneously meet multiple design requirements such as high performance and thinness.

Sound-generating devices are important electroacoustic transducers in consumer electronics, widely used as speakers, earpieces, and headphones. With the improvement of electronic product performance, the improvement of the acoustic performance of sound-generating devices is an inevitable trend.

The sound-generating device in the related art includes a basket, a vibration system fixed to the basket, and a magnetic circuit system with a magnetic gap. The magnetic circuit system drives the vibration system to vibrate and generate sound. The vibration system includes a diaphragm fixed to the basket for sound generation, a dome attached to the diaphragm, and a voice coil that is inserted into the magnetic gap and connected to the dome to drive the diaphragm to vibrate. In other words, the sound-generating device drives the diaphragm in the vibration system through the magnetic circuit system, repeatedly pushing air to generate sound. The diaphragm, as the core component of the sound-generating device, directly affects the acoustic performance of the sound-generating device. The effective vibration area (Sd) of the diaphragm is one of the important factors affecting the acoustic performance of the sound-generating device; the larger the effective vibration area, the better the acoustic performance of the sound-generating device.

However, for sound-generating devices in the related art, the vibration system and the magnetic circuit system are stacked vertically. This restricts the structure of the magnetic circuit system within a sound-generating device of the same height, thus limiting the BL value of the magnetic field. Furthermore, the effective vibration area of the diaphragm in these related devices is relatively small, affecting the acoustic performance of the sound-generating device.

In view of above concepts and problems, the present application proposes a sound-generating device 100. The sound-generating device 100 is applied to an electronic device, which can be the mobile phone, headphones, smart wearable devices, and the like, which is not limited here. In this embodiment, the diaphragm 34 and the second diaphragm assembly 32 are provided at a conventional loudspeaker of the sound-generating device 100 of the present application. When the sound-generating device 100 is working, the relative volume change between the diaphragm 34 and the second diaphragm assembly 32 pushes air, thereby increasing the effective vibration area of the sound-generating device 100 and improving the performance of the sound-generating device 100.

It can be understood that, the sound-generating device 100 of the present application increases the effective vibration area (Sd) by using the Z-axis space of the sound-generating device 100, thereby increasing Sd, which also compensates for the loss of Sd in the first diaphragm assembly 31 caused by the addition of a magnet to the intermediate magnetic circuit. Furthermore, the addition of a magnet to the intermediate magnetic circuit increases the magnetic field strength of the magnetic gap 24, further improving the performance of the sound-generating device 100. The sound-generating device 100 of the present application also achieves high-performance and lightweight. Compared to conventional speakers, the performance of the sound-generating device 100 is improved under the same amplitude conditions, which also reduces amplitude while maintaining the same performance, resulting in a thinner and lighter product.

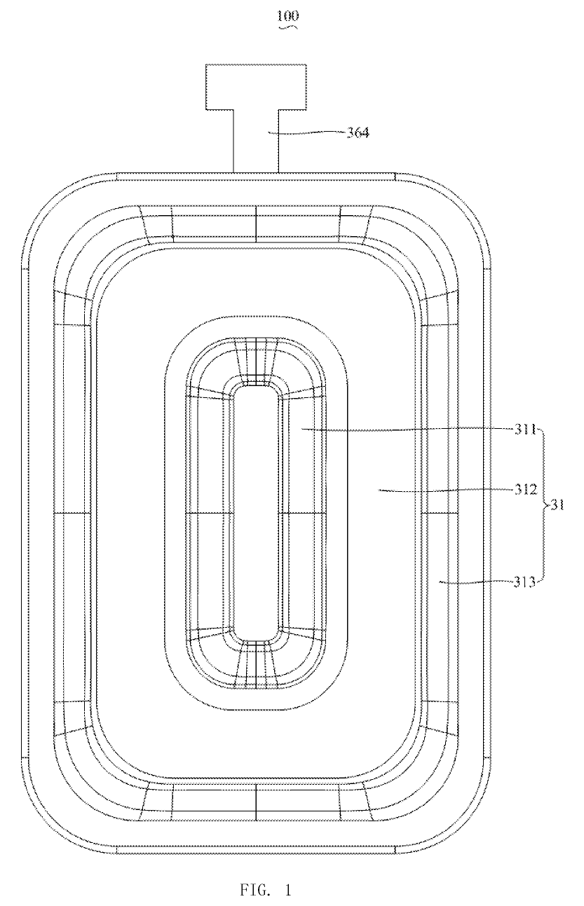

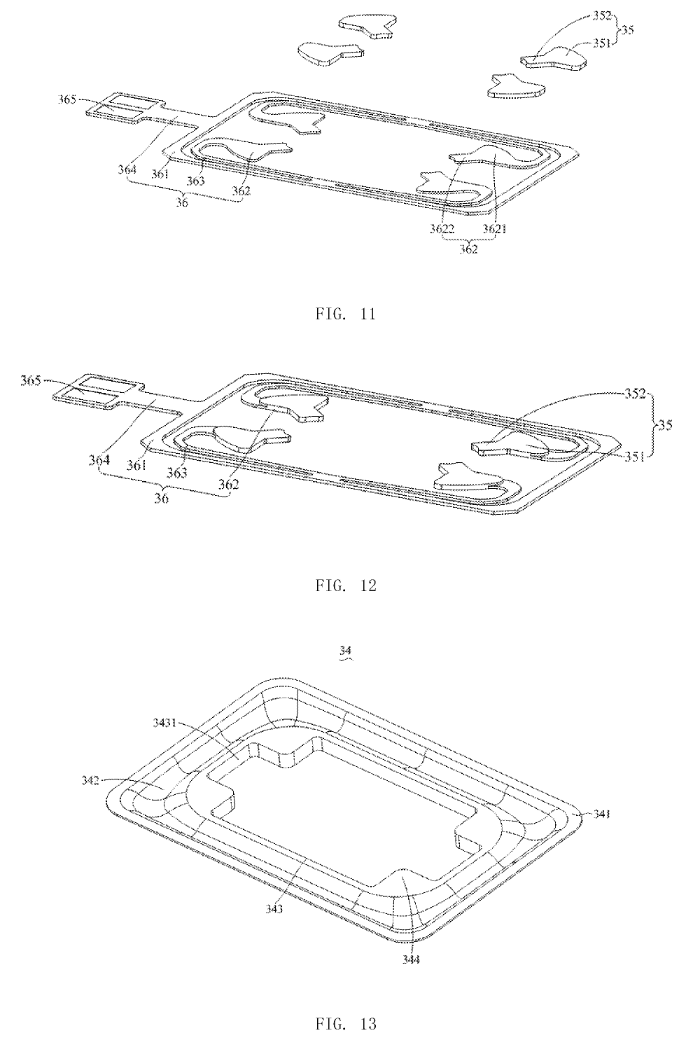

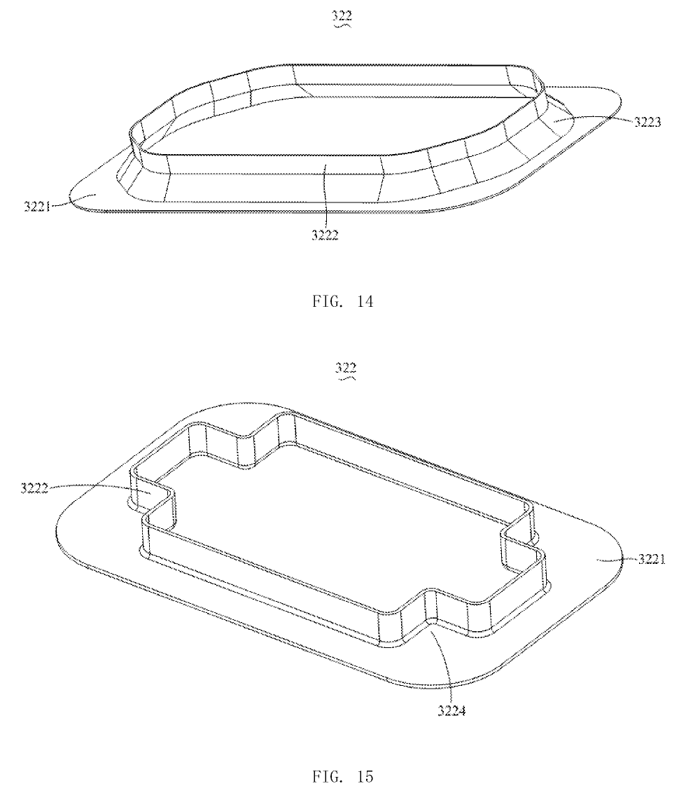

As shown in FIG. 1 to FIG. 15, in this embodiment of the application, the sound-generating device 100 includes a housing 1, a magnetic circuit system 2, and a vibration system 3. The housing 1 is provided with a sound hole 111. The magnetic circuit system 2 is connected to the housing 1. The magnetic circuit system 2 includes a magnetic conductive yoke 21, a central magnetic portion 22 and a side magnetic portion 23. The central magnetic portion 22 and the side magnetic portion 23 are provided at the magnetic conductive yoke 21. The side magnetic portion 23 is located outside the central magnetic portion 22 and forms a magnetic gap 24 with the central magnetic portion 22. The central magnetic portion 22 includes a first central magnet 221, a central magnetic conductive plate 222, and a second central magnet 223 stacked together. Both the first central magnet 221 and the second central magnet 223 are magnetized along the vibration direction of the vibration system 3; the magnetization direction of the first central magnet 221 is opposite to the magnetization direction of the second central magnet 223. The first central magnet 221 is connected to the magnetic conductive yoke 21. The vibration system 3 includes a first diaphragm assembly 31, the second diaphragm assembly 32, the voice coil 33, the diaphragm 34, and the rigid connector 35. The first diaphragm assembly 31 includes an inner folded ring 311, a first vibration plate 312, and an outer folded ring 313 connected in sequence. The inner side of the inner folded ring 311 is connected to the second central magnet 223. The outer periphery of the outer folded ring 313 is connected to the housing 1. One end of the voice coil 33 is connected to the first diaphragm assembly 31, and the other end of the voice coil 33 is suspended in the magnetic gap. The diaphragm 34 and the second diaphragm assembly 32 are sequentially provided at one side of the first diaphragm assembly 31 facing the magnetic conductive yoke 21, and located outside the voice coil 33. The outer edges of both the diaphragm 34 and the second diaphragm assembly 32 are connected to the housing 1. The inner edge of the diaphragm 34 is connected to the inner edge of the second diaphragm assembly 32, forming a sound-generating cavity 4 between the diaphragm 34 and the second diaphragm assembly 32. The sound-generating cavity 4 communicates with the sound hole 111. One end of the rigid connector 35 is connected to the second diaphragm assembly 32, and the other end of the rigid connector 35 is connected to the voice coil 33, so that the voice coil 33 drives the second diaphragm assembly 32 to vibrate through the rigid connector 35.

In this embodiment, the sound-generating device 100 can be a single unit of a loudspeaker, and the loudspeaker can be a miniature loudspeaker. The magnetic circuit system 2 is disposed opposite to the vibration system 3.

In an embodiment, the magnetic circuit system 2 is in a square shape. For example, the magnetic circuit system 2 may include a central magnetic portion 22 and a side magnetic portion 23, and both the central magnetic portion 22 and the side magnetic portion 23 are the square structures. In this embodiment, the vibration system 3 is in a square shape. The periphery of the first diaphragm assembly 31 of the vibration system 3 can be connected to the magnetic circuit system 2, or the magnetic circuit system 2 and the vibration system 3 can be respectively mounted on the loudspeaker housing, and the like, which is not limited here.

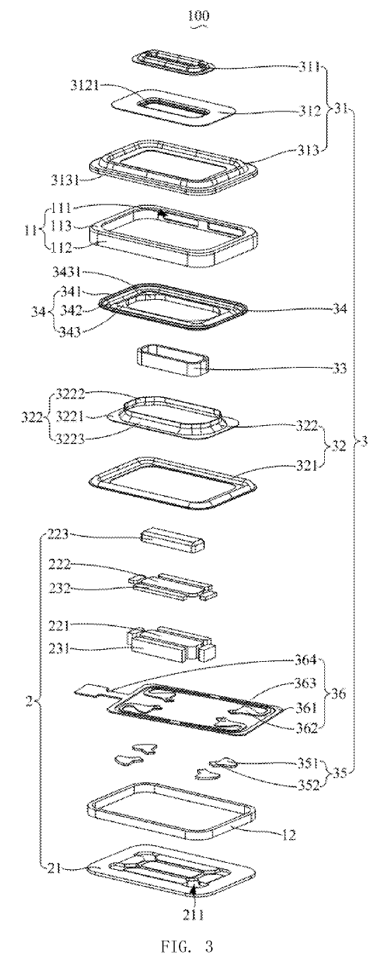

To better assemble the magnetic circuit system 2 and the vibration system 3 of the sound-generating device 100, in an embodiment, as shown in FIG. 3 to FIG. 6, the sound-generating device 100 further includes a housing 1. Both the magnetic circuit system 2 and the vibration system 3 are connected to the housing 1. The magnetic conductive yoke 21 of the magnetic circuit system 2 is connected to one end of the housing 1. The periphery of the first diaphragm assembly 31 of the vibration system 3 is connected to the other end of the housing 1, and is disposed opposite to the magnetic circuit system 100. The inner periphery of the first diaphragm assembly 31 is connected to the central magnetic portion 22 of the magnetic circuit system 2.

In this embodiment, the housing 1 is used to install, fix, and support components such as the magnetic circuit system 2 and the vibration system 3; that is, the housing 1 provides a mounting base for the components such as the magnetic circuit system 2 and the vibration system 3. The housing 1 can be a single integral structure or formed by multiple separate structures, which is not limited here. In this embodiment, the housing 1 can be a square frame or a rectangular frame structure, that is, the housing 1 is provided with a cavity with openings at both ends. The magnetic circuit system 2 and the vibration system 3 are respectively connected to both sides of the housing 1, so that the magnetic circuit system 2, the housing 1, and the first diaphragm assembly 31 of the vibration system 3 enclose a vibration cavity.

In this embodiment, the housing 1 is used to hold the vibration system 3 and the magnetic circuit system 2, allowing the sound-generating device 100 to be used as an independent component in an electronic device or a sound-generating module, which is not limited here.

It can be understood that, the magnetic circuit system 2 includes a magnetic conductive yoke 21, and a central magnetic portion 22 and a side magnetic portion 23; the central magnetic portion 22 and the side magnetic portion 23 are located on the magnetic conductive yoke 21; the magnetic circuit system 2 can be connected to the housing 1 through the periphery of the magnetic conductive yoke 21. In this embodiment, the side magnetic portion 23 is provided outside the central magnetic portion 22, and forms a magnetic gap 24 with the central magnetic portion 22. In this way, the first diaphragm assembly 31 of the vibration system 3 can be connected to the end of the housing 1 away from the magnetic conductive yoke 21. The inner side of the first diaphragm assembly 31 is connected to the central magnetic portion 22. One end of the voice coil 33 is connected to the first diaphragm assembly 31. The other end of the voice coil 33 is suspended within the magnetic gap 24. When current passes through the voice coil 33, electrical energy can be converted into mechanical energy within the magnetic gap 24 formed by the voice coil 33 of the magnetic circuit system 2, driving the voice coil 33 to make the first diaphragm assembly 31 vibrate, thereby generating sound. Furthermore, by configuring the central magnetic portion 22 as a opposed magnetic structure, the first central magnet 221, the central magnetic conductive plate 222, and the second central magnet 223 are sequentially stacked vertically on the magnetic conductive yoke 21. Both the first central magnet 221 and the second central magnet 223 are magnetized along the vibration direction of the vibration system 3, and the magnetization direction of the first central magnet 221 is opposite to that of the second central magnet 223. Thus, utilizing the magnetic conductivity of the central magnetic conductive plate 222, the magnetic field lines of the first central magnet 221 and the second central magnet 223 are concentrated on the central magnetic conductive plate 222, and the central magnetic conductive plate 222 will transmit these magnetic field lines to the magnetic gap 24. In this way, the central magnetic portion 22 can generate a magnetic field with a relatively strong magnetic field intensity, and the magnetic field will pass through the magnetic gap 24, thereby increasing the magnetic flux density of the magnetic gap 24, increasing the number of magnetic force lines that pass through the voice coil 33, increasing the magnetic force on the voice coil 33, and effectively improving the BL value.

In this embodiment, the first diaphragm assembly 31 includes an inner folded ring 311, a first vibration plate 312, and an outer folded ring 313 connected in sequence. The inner side of the inner folded ring 311 is connected to the second central magnet 223, and the outer periphery of the outer folded ring 313 is connected to the housing 1. In this way, the first diaphragm assembly 31 can be fixed; the vibration performance and compliance of the first diaphragm assembly 31 can be improved through the inner folded ring 311 and the outer folded ring 313. The first vibration plate 312 is connected to the voice coil 33; or, the first vibration plate 312 is connected to the voice coil 33 through a connector or a frame, which is not limited here.

In an embodiment, the first vibration plate 312 is made of metal or fiber material. In this embodiment, the vibration plate is bonded to or integrally injection molded to the outer folded ring 313 and the inner folded ring 311, respectively. The inner folded ring 311, the first vibration plate 312 , and the outer folded ring 313 of the first diaphragm assembly 31 can also be integrally molded structures, which ensures the structural strength of the first diaphragm assembly 31 and simplifies the processing steps, and the structure is not limited here.

In this embodiment, the outer periphery of the first vibration plate 312 forms a first stepped surface, and the inner periphery of the first vibration plate 312 forms a second stepped surface. The inner side of the outer folded ring 313 extends along a direction perpendicular to the vibration direction of the vibration system 3 to form an inner ring portion, and the outer side of the inner folded ring 311 extends along a direction perpendicular to the vibration direction of the vibration system 3 to form an outer ring portion. The inner ring portion overlaps with the first stepped surface and is bonded to the first stepped surface. The outer ring portion overlaps with the second stepped surface and is bonded to the second stepped surface.

It can be understood that, the first vibration plate 312 being bond to the outer folded ring 313 and the inner folded ring 311, not only improves the connection stability, but also makes the assembly structure more compact and ensures the vibration performance of the entire first diaphragm assembly 31. In other embodiments, the inner ring portion of the outer folded ring 313 and the outer ring portion of the inner folded ring 311 can both be connected to the same side of the first vibration plate 312 (such as the upper surface or the lower surface of the first vibration plate 312), or the inner ring portion of the outer folded ring 313 and the outer ring portion of the inner folded ring 311 can be connected to different sides of the first vibration plate 312, which is not limited here.

In this embodiment, as shown in FIG. 1 and FIG. 3 to FIG. 6, the inner folded ring 311 of the first diaphragm assembly 31 can be a sealed structure, meaning the inner side of the inner folded ring 311 is a flat plate, and this inner side shaped of a flat plate is connected and fitted to the side of the central magnetic portion 22 of the magnetic circuit system 2 away from the magnetic conductive yoke 21.

In other embodiments, the first diaphragm assembly 31 can be an annular structure. In this embodiment, the inner folded ring 311 is provided with a hole at the inner side of the inner folded ring 311, with part of the central magnetic portion 22 exposed through the hole or part of the central magnetic portion 22 passing through the hole, which is not limited here.

In this embodiment, the outer folded ring 313 and the inner folded ring 311 of the first diaphragm assembly 31 can be either an upwardly convex structure or a downwardly concave structure, which is not limited here. To avoid the diaphragm 34 and the second diaphragm assembly 32, the outer folded ring 313 of the first diaphragm assembly 31 may protrude in a direction away from the magnetic circuit system 2. To prevent interference between the inner folded ring 311 of the first diaphragm assembly 31 and the central magnetic portion 22 of the magnetic circuit system 2 during vibration, the inner folded ring 311 of the first diaphragm assembly 31 may protrude in a direction away from the magnetic circuit system 2. In an embodiment, both the inner folded ring 311 and the outer folded ring 313 protrude in a direction away from the magnetic circuit system 2.

To further increase the connection area between the outer folded ring 313 of the first diaphragm assembly 31 and the housing 1 and improve stability, in this embodiment, as shown in FIG. 3 to FIG. 6, the outer periphery of the outer folded ring 313 is bent and extended to form a third flange 3131, which is connected to the outer wall of the housing 1. The outer periphery of the outer folded ring 313 is provided with a flat portion parallel to the first vibration plate 312 which is connected to the end face of the housing 1. The outer side of the flat portion bends and extends towards the magnetic circuit system 2 to form the third flange 3131, to make the third flange 3131 connected to the outer sidewall of the housing 1, thereby increasing the connection area between the outer folded ring 313 and the housing 1 and improving connection stability and waterproof sealing performance.

To achieve electrical connection between the voice coil 33 and the external circuit, in an embodiment, as shown in FIG. 3 to FIG. 12, the vibration system 3 further includes a centering sheet 36. One end of the centering sheet 36 is connected to the voice coil 33 and is electrically connected to the lead wire of the voice coil 33. The other end of the centering sheet 36 is connected to the housing 1.

It can be understood that both ends of the centering sheet 36 are electrically connected to the lead wire of the voice coil 33 and the external circuit, respectively. In this embodiment, the centering sheet 36 can be disposed at the bottom of the voice coil 33, and located at one of the four corners of the sound-generating device 100, or located along the short or long axis. The centering sheet 36 can also be disposed at the top of the voice coil 33, provided between the voice coil 33 and the diaphragm 31, which is not limited here.

In this embodiment, the diaphragm 34 and the second diaphragm assembly 32 of the vibration system 3 are sequentially disposed on one side of the first diaphragm assembly 31 facing the magnetic conductive yoke 21 and located outside the voice coil 33. This ensures that the outer edges of both the diaphragm 34 and the second diaphragm assembly 32 are connected to the housing 1, and the inner edge of the diaphragm 34 is connected to the inner edge of the second diaphragm assembly 32, thereby forming a sound-generating cavity 4 between the diaphragm 34 and the second diaphragm assembly 32. A sound hole 111 is provided at the housing 1, allowing the sound-generating cavity 4 to communicate with the sound hole 111. One end of the rigid connector 35 is connected to the second diaphragm assembly 32. The other end of the rigid connector 35 is connected to the voice coil 33, thus allowing the voice coil 33 to drive the second diaphragm assembly 32 to vibrate through the rigid connector 35.

It can be understood that, when current passes through the voice coil 33, the voice coil 33 converts electrical energy into mechanical energy within the magnetic gap 24 formed within the magnetic circuit system 2. This mechanical energy drives the voice coil 33 to make the first diaphragm assembly 31 vibrate, thus generating sound. In addition, the voice coil 33 drives the second diaphragm assembly 32 to vibrate through the rigid connector 35. In this case, a volume between the diaphragm 34 and the second diaphragm assembly 32 will change, so that the air in the sound-generating cavity 4 can pass through the sound hole 111 smoothly. In this case, the sound-generating device 100 adds the diaphragm 34 and the second diaphragm assembly 32 to a conventional loudspeaker. When the sound-generating device 100 is working, the voice coil 33 simultaneously drives the first diaphragm assembly 31, the second diaphragm assembly 32, and the diaphragm 34 to vibrate, thereby increasing the effective vibration area of the sound-generating device 100 and improving performance of the sound-generating device 100.

In this embodiment, the structure of the second diaphragm assembly 32 can be a diaphragm structure or other structures capable of vibrating and generating sound, which is not limited here. The structure of the diaphragm 34 can be a structure capable of vibrating and deforming. In an embodiment, the diaphragm 34 is a flexible component, made of a single-layer polyether-ether-ketone (PEEK) membrane, composite PEEK membrane, or other flexible materials. It can be understood that, the rigid connector 35 connects the voice coil 33 and the second diaphragm assembly 32, allowing the voice coil 33 to drive the second diaphragm assembly 32 to vibrate through the rigid connector 35. The rigid connector 35 can be made of stainless steel or other metals, or carbon fiber or other materials with sufficient strength, which is not limited here.

The sound-generating cavity 4 formed between the diaphragm 34 and the second diaphragm assembly 32 is a sealed front cavity. When the sound-generating device 100 is working, the vibration directions of the first diaphragm assembly 31 and the second diaphragm assembly 32 are the same. The volume change of the sound-generating cavity 4 increases the volume of pushed air during working, thereby increasing the effective vibration area of the product. In addition, by providing the diaphragm 34 and the second diaphragm assembly 32, the sound-generating device 100 utilizes its Z-axis space to increase its effective vibration area, thereby increasing the Sd of the sound-generating device. This also reduces the Sd loss caused by the connection between the inner folded ring 311 of the first diaphragm assembly 31 and the central magnetic portion 22, thus improving the performance of the sound-generating device 100.

In an embodiment, the effective vibration area Sd1 of the diaphragm 34 is smaller than the effective vibration area Sd2 of the second diaphragm assembly 32, with the ratio of Sd1 to Sd2 ranged form 1:1.5 to 1:3. In this embodiment, the ratio of the effective vibration area Sd1 of the diaphragm 34 to the effective vibration area Sd2 of the second diaphragm assembly 32 can be 1:1.5, 1:1.8, 1:2, 1:2.3, 1:2.5, 1:2.8, 1:3, and the like, which is not limited here.

In this way, when the voice coil 33 drives the second diaphragm assembly 32 to vibrate through the rigid connector 35, the second vibration plate 322 of the second diaphragm assembly 32 drives the diaphragm 34 to vibrate and deform. In this case, the diaphragm 34 has a reverse effect on pushing air, while the second diaphragm assembly 32 has a positive effect on pushing air. The volume change of the sound-generating cavity 4 can be used to increase the volume of pushed air during working, thereby increasing the effective vibration area of the product.

The sound-generating device 100 of the present application holds a magnetic circuit system 2 and a vibration system 3 within a housing 1. The magnetic circuit system 2 includes a magnetic conductive yoke 21, a central magnetic portion 22, and a side magnetic portion 23; the central magnetic portion 22 and the side magnetic portion 23 are provided at the magnetic conductive yoke 21. The side magnetic portion 23 is provided outside the central magnetic portion 22 and forms a magnetic gap 24 with the central magnetic portion 22. The vibration system 3 includes the first diaphragm assembly 31, the second diaphragm assembly 32, the voice coil 33, the diaphragm 34, and the rigid connector 35. The inner side of the inner folded ring 311 of the first diaphragm assembly 31 is connected to the central magnetic portion 22, and the outer periphery of the outer folded ring 311 is connected to the housing 1. One end of the voice coil 33 is connected to the first diaphragm assembly 31, and the other end of the voice coil 33 is suspended in the magnetic gap 24. When current passes through the voice coil 33, electrical energy can be converted into mechanical energy within the magnetic gap 24 formed within magnetic circuit system 2, driving the voice coil 33 to make the first diaphragm assembly 31 vibrate, thus generating sound. In addition, the diaphragm 34 and the second diaphragm assembly 32 are sequentially provided at the side of the first diaphragm assembly 31 facing the magnetic conductive yoke 21, and located outside the voice coil 33, so that the outer edges of the diaphragm 34 and the second diaphragm assembly 32 are connected to the housing 1, and the inner edge of the diaphragm 34 is connected to the inner edge of the second diaphragm assembly 32, forming a sound-generating cavity 4 between the diaphragm 34 and the second diaphragm assembly 32. A sound hole 111 is provided in the housing 1, and the sound hole 111 communicates with the sound-generating cavity 4. One end of the rigid connector 35 is connected to the second diaphragm assembly 32, and the other end of the rigid connector 35 is connected to the voice coil 33. In this way, the voice coil 33 can drive the second diaphragm assembly 32 to vibrate through the rigid connector 35. Thus, by adding a diaphragm 34 and a second diaphragm assembly 32 to a conventional loudspeaker, when the sound-generating device 100 is working, the voice coil 33 drives the second diaphragm assembly 32 to vibrate through the rigid connector 35. In this case, a volume between the diaphragm 34 and the second diaphragm assembly 32 will change, so that the air in the sound-generating cavity 4 can pass through the sound hole 111 smoothly, which increases the effective vibration area of the sound-generating device 100, thereby improving performance. Furthermore, by configuring the central magnetic portion 22 as a magnetic-opposite structure, the magnetic field strength of the magnetic circuit system 2 of the sound-generating device 100 can be increased, thus improving the overall performance of the sound-generating device 100.

In an embodiment, the first vibration plate 312 bends and extends towards the voice coil 33 to form a second bending portion 3121, which is connected to the voice coil 33.

In this embodiment, as shown in FIG. 3 to FIG. 5, by providing the second bending portion 3121 at the first vibration plate 312, the second bending portion 3121 extends towards the voice coil 33, the first vibration plate 312 is connected to the voice coil 33 through the second bending portion 3121. In this way, the voice coil 33 can be suspended at a suitable position within the magnetic gap 24 by using the second bending portion 3121, ensuring the magnetic circuit system 2 drives the voice coil 33 to vibrate effectively.

It can be understood that, the second bending portion 3121 is formed by bending and extending the inner side of the first vibration plate 312 towards the voice coil 33. In an embodiment, the first vibration plate 312 and the second bending portion 3121 are integrally formed, such as integrally injection molded or integrally stamped, and the like, which is not limited here.

In another embodiment, the first diaphragm assembly 31 further includes a bracket. Two ends of the bracket are respectively connected to the first vibration plate 312 and the voice coil 33. It can be understood that, the bracket can be connected to the first vibration plate 312 through bonding, welding, or integral injection molding. In this way, the first vibration plate 312 can be connected to the voice coil 33 through the bracket, thus suspending the voice coil 33 in a suitable position within the magnetic gap 24, ensuring the magnetic circuit system 2 drives the voice coil 33 to vibrate effectively.

In an embodiment, the second diaphragm assembly 32 includes a folded ring portion 321 and a second vibration plate 322. The outer periphery of the folded ring portion 321 is connected to the housing 1. The second vibration plate 322 includes a main body portion 3221 connected to the inner edge of the folded ring portion 321, and a first bending portion 3222 formed by bending the main body portion 3221 toward the diaphragm 34. The first bending portion 3222 is connected to the inner edge of the diaphragm 34.

In this embodiment, the folded ring portion 321 of the second diaphragm assembly 32 can be an upwardly convex structure or a downwardly concave structure, which is not limited here. To facilitate the connection between the folded ring portion 321 and the housing 1, as shown in FIG. 4 to FIG. 6, the outer periphery of the folded ring portion 321 is bent to form a first flange 3211 which connects to the outer wall of the housing 1.

It can be understood that, the first flange 3211 is formed by extending the outer periphery of the folded ring portion 321 along the vibration direction of the vibration system. The first flange 3211 is connected to the outer sidewall of the housing 1, thus increasing the connection area between the folded ring portion 321 and the housing 1, and improving connection stability and waterproof sealing. Of course, the outer side of the folded ring portion 321 is provided with a horizontal portion extending along a direction perpendicular to the vibration direction of the vibration system. This horizontal portion is connected to the end face of the housing 1. The outer side of the horizontal portion extends along the vibration direction of the vibration system to form a first flange 3211, which is not limited here.

In this embodiment, the second vibration plate 322 includes the main body portion 3221 and the first bending portion 3222; the end of the main body portion 3221 away from the first bending portion 3222 is connected to the inner edge of the folded ring portion 321, and the first bending portion 3222 is connected to the inner edge of the diaphragm 34. In this way, the inner edge of the diaphragm 34 can be connected to the side edge of the second diaphragm assembly 32, so that the diaphragm 34, the second vibration plate 322 of the second diaphragm assembly 32, the folded ring portion 321, and the housing 1 form the sound-generating cavity 4. The second vibration plate 322 of the second diaphragm assembly 32 is connected to the voice coil 33 through the rigid connector 35. When the voice coil 33 drives the second diaphragm assembly 32 to vibrate through the rigid connector 35, the second vibration plate 322 of the second diaphragm assembly 32 causes the diaphragm 34 to vibrate and deform.

In an embodiment, the folded ring portion 321 of the second diaphragm assembly 32 and the second vibration plate 322 are bonded together or integrally injection molded, which is not limited here. In this embodiment, the main body portion 3221 and the first bending portion 3222 of the second vibration plate 322 are integrally molded. The first bending portion 3222 is formed by bending and extending the main body portion 3221 toward the diaphragm 34, for example, by injection molding or stamping, which is not limited here.

In an embodiment, an inclined portion 3223 is formed at the connection between the main body portion 3221 and the first bending portion 3222. An angle is formed between the inclined portion 3223 and the vibration direction of the vibration system 3.

As shown in FIG. 3 to FIG. 5 and FIG. 14, an angle is formed between the plane where the inclined portion 3223 is located and the vibration direction of the vibration system 3. This angle can be greater than 0° and less than 90°. The inclined portion 3223 can improve the rigidity of the second vibration plate 322 in the horizontal direction (namely, the direction perpendicular to the vibration direction of the vibration system 3), thereby improving the vibration performance of the second diaphragm assembly 32 and increasing the feasibility of molding. In addition, the distance between the inclined portion 3223 and the magnetic circuit system 2 is greater than the distance between the inner edge of the second vibration plate 322 and the magnetic circuit system 2, allowing the outer edge of the magnetic circuit system 2 to tilt outwards, thereby increasing the size of the magnetic circuit system 2 and further improving the BL of the sound-generating device 100. Furthermore, the inclined portion 3223 facilitates the positioning and connection between the second vibration plate 322 and the folded ring portion 321, improving connection accuracy. In an embodiment, the second vibration plate 322 can be made of magnesium-aluminum alloy, magnesium-lithium alloy, and the like, which is not limited here.

In an embodiment, the diaphragm 34 is a flexible component. The diaphragm 34 includes an outer connecting portion 341, a deformable portion 342, and an inner connecting portion 343 connected sequentially. The outer periphery of the outer connecting portion 341 is connected to the housing 1, and the inner edge of the inner connecting portion 343 is connected to a first bending portion 3222. The deformable portion 342 is in a bent shape.

In this embodiment, as shown in FIG. 3 to FIG. 5 and FIG. 13, by configuring the diaphragm 34 as a flexible component, when the voice coil 33 drives the second diaphragm assembly 32 to vibrate through the rigid connector 35, the second vibration plate 322 of the second diaphragm assembly 32 causes the diaphragm 34 to vibrate and deform. In this case, a volume between the diaphragm 34 and the second diaphragm assembly 32 will change, so that the air in the sound-generating cavity 4 can pass through the sound hole 111 smoothly, which increases the effective vibration area of the sound-generating device 100 during vibration , thereby improving performance.

It is understood that, the diaphragm 34 includes an outer connecting portion 341, a deformable portion 342, and an inner connecting portion 34; the outer periphery of the outer connecting portion 341 is connected to the housing 1, and the inner edge of the inner connecting portion 343 is connected to the first bending portion 3222. In this way, not only the diaphragm 34 can be fixed to the housing 1 through the outer connecting portion 341, but also the diaphragm 34 can be fixed to the inner edge of the second diaphragm assembly 32 through the inner connecting portion 343. Therefore, a sealed sound-generating cavity 4 can be formed between the diaphragm 34 and the second diaphragm assembly 32. In addition, the deformable portion 342 is in a bent shape, thereby increasing the deformability of the diaphragm 34. Therefore, when the voice coil 33 drives the second diaphragm assembly 32 to vibrate through the rigid connector 35, the second vibration plate 322 of the second diaphragm assembly 32 causes the diaphragm 34 to vibrate and deform.

In an embodiment, the inner edge of the inner connecting portion 343 bends and extends towards the first bending portion 3222 to form a second flange 3431, which is connected to the first bending portion 3222.

In this embodiment, as shown in FIG. 3 to FIG. 5 and FIG. 13, by providing a second flange 3431 at the inner edge of the inner connecting portion 343 and connecting the second flange 3431 with the first bending portion 3222, not only the connection stability is improved, but also the waterproof sealing performance is further enhanced. In an embodiment, the second flange 3431 is formed by bending and extending the inner edge of the inner connecting portion 343 towards the first bending portion 3222.

In an embodiment, the outer connecting portion 341, the deformable portion 342, the inner connecting portion 343, and the second flange 3431 of the diaphragm 34 are integrally formed, such as integrally injection molded or integrally stamped, and the like, which is not limited here.

In this embodiment, the compliance of the diaphragm 34 is greater than the compliance of the folded ring portion 321. In this case, the diaphragm 34 can only serve an isolation and sealing function when the voice coil 33 drives the second diaphragm assembly 32 to vibrate through the rigid connector 35, without generating a reverse force on the vibration of the second diaphragm assembly 32, thus improving the low-frequency sensitivity of the speaker.

It can be understood that, the compliance of the diaphragm 34 can be greater than the compliance of the inner folded ring 311 of the first diaphragm assembly 31, and the compliance of the diaphragm 34 can be greater than the compliance of the outer folded ring 313 of the first diaphragm assembly 31. In this way, the diaphragm 34 only serves a sealing function and will not produce a reverse effect on the vibration of the first diaphragm assembly 31 and the second diaphragm assembly 32, thereby improving low-frequency sensitivity.

In an embodiment, the deformable portion 342 protrudes in a direction away from the first diaphragm assembly 31, and the folded ring portion 321 protrudes in a direction closer to the first diaphragm assembly 31. The deformable portion 342 and the folded ring portion 321 are distributed in a staggered manner along in a direction perpendicular to the vibration system 3. It can be understood that, this arrangement prevents interference between the folded ring portion 321 of the second diaphragm assembly 32 and the deformable portion 342 of the diaphragm 34 during vibration. In other embodiments, the folded ring portion 321 may also protrude in a direction away from the first diaphragm assembly 31, which is not limited here.

In an embodiment, along the vibration direction of the vibration system 3, the projection width L1 of the deformable portion 342 is greater than or equal to the projection width L2 of the folded ring portion 321, and the ratio of L1 to L2 is ranged form 1:1 to 3:1.

In this embodiment, as shown in FIG. 4, along the vibration direction of the vibration system 3, by setting the projection width L1 of the deformable portion 342 of the diaphragm 34 to be greater than or equal to the projection width L2 of the folded ring portion 321 of the second diaphragm assembly 32, the effective vibration area Sd2 of the second diaphragm assembly 32 is greater than the effective vibration area Sd1 of the diaphragm 34. Thus, when the voice coil 33 drives the second diaphragm assembly 32 and the diaphragm 34 to vibrate, the diaphragm 34 has a reverse effect on pushing the air volume, while the second diaphragm assembly 32 has a positive effect on pushing the air volume. This utilizes the volume change of the sound-generating cavity 4 to increase the volume of pushed air during working, thereby increasing the effective vibration area of the product.

In an embodiment, the ratio of L1 to L2 can be 1:1, 1.5:1, 2:1, 2.5:1, 3:1, and the like, which is not limited here.

In an embodiment, there are multiple side magnetic portions 23, and an avoidance space 233 is formed between adjacent side magnetic portions 23. The second vibration plate 322 is provided with a first extension portion 3224 extending into the avoidance space 233, and the diaphragm 34 is provided with a second extension portion 344 extending into the avoidance space 233. The second extension portion 344 is correspondingly connected to the first extension portion 3224.

In this embodiment, as shown in FIG. 3, FIG. 7 to FIG. 9, and FIG. 15, multiple side magnetic portions 23 are arranged around the outside of the central magnetic portion 22 at intervals. In this case, an avoidance space 233 can be formed between adjacent side magnetic portions 23. This avoidance space 233 provides avoidance and movement space for the rigid connector 35. That is, the the rigid connector 35 is provided within the avoidance space 233; one end of the the rigid connector 35 is connected to the second diaphragm assembly 32, and the other end of the the rigid connector 35 is connected to the voice coil 33. In this way, the voice coil 33 can drive the second diaphragm assembly 32 to vibrate through the rigid connector 35.

It can be understood that, a first extension portion 3224 is provided at the second diaphragm assembly 32, and the first extension portion 3224 extends toward the avoidance space 233 and is connected to the rigid connector 35, so that the connection stability between the second diaphragm assembly 32 and the rigid connector 35 can be increased, ensuring that the voice coil 33 drives the second diaphragm assembly 32 to vibrate through the rigid connector 35. In an embodiment, the second vibration plate 322 extends toward the avoidance space 233 to form the first extension portion 3224.

In this embodiment, as shown in FIG. 13, the diaphragm 34 is provided with a second extension portion 344 extending into the avoidance space 233. This second extension portion 344 is connected to the first extension portion 3224, thereby further increasing the connection stability and sealing between the diaphragm 34 and the second vibration plate 322. It is understood that, as shown in FIG. 13, both the inner connecting portion 343 and the second flange 3431 of the diaphragm 34 extend into the avoidance space 233, forming the second extension portion 344, which is not limited here.

In another embodiment, there are multiple the side magnetic portions 23, with an avoidance space 233 formed between adjacent side magnetic portions 23. The voice coil 33 is provided with a first protrusion portion 331 extending into the avoidance space 233, and the central magnetic portion 22 is provided with a second protrusion portion 224 extending into the avoidance space 233. The first protrusion portion 331 and the second protrusion portion 224 are disposed opposite to each other.

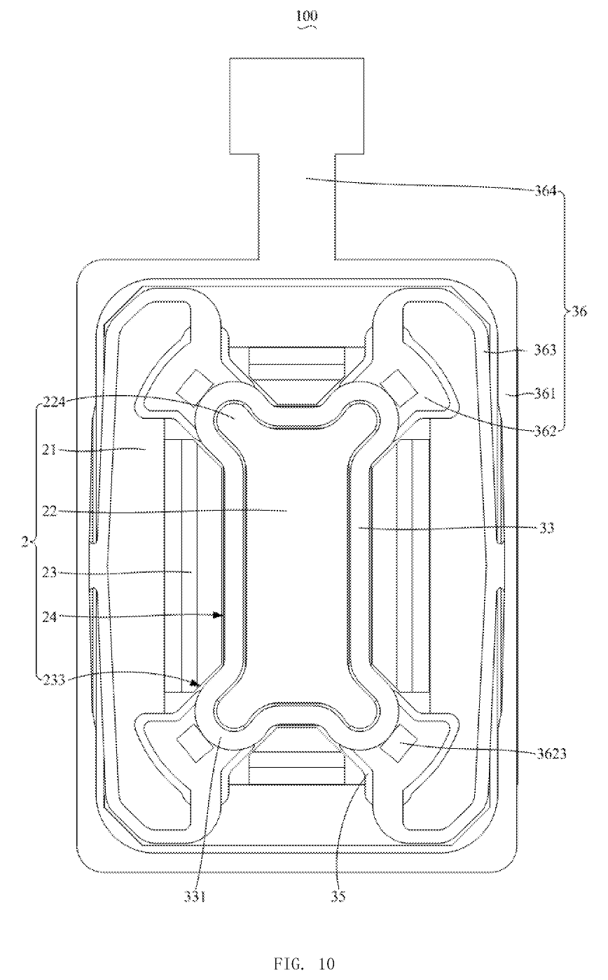

In this embodiment, as shown in FIG. 10, multiple side magnetic portions 23 are arranged around the outside of the central magnetic portion 22 at intervals, forming an avoidance space 233 between adjacent side magnetic portions 23. A first protrusion portion 331 is provided at the voice coil 33, and the first protrusion portion 331 extends into the avoidance space 233. A second protrusion portion 224 is provided at the central magnetic portion 22, and the second protrusion portion 224 extends into the avoidance space 233. The first protrusion portion 331 is disposed and spaced apart from the second protrusion portion 224 correspondingly. This distribution increases the length of the wire of the voice coil 33, so that the rigid connector 35 can connect the voice coil 33 with the second diaphragm assembly 32. Furthermore, it increases the magnet volume in the central magnetic portion 22, thereby effectively enhancing the magnetic field strength, further improving the BL value of the sound-generating device 100.

It can be understood that, the central magnetic portion 22 can be a rectangular structure, and the voice coil 33 can be a rectangular voice coil. The avoidance space 233 of the side magnetic portion 23 corresponds to the corner position of the central magnetic portion 22. Each of the four corner positions of the voice coil 33 is provided with a first protrusion portion 331. Each of the four corner positions of the central magnetic portion 22 is provided with a second protrusion portion 224, which is not limited here.

In an embodiment, the vibration system 3 further includes a centering sheet 36 which includes an outer fixing portion 361, an inner fixing portion 362, and a vibration arm 363 connecting the outer fixing portion 361 and the inner fixing portion 362. The outer fixing portion 361 is connected to the housing 1, and the rigid connector 35 is provided at the inner fixing portion 362. The second diaphragm assembly 32 includes a folded ring portion 321 and a second vibration plate 322 connected to the folded ring portion 321. The outer periphery of the folded ring portion 321 is connected to the housing 1, and the inner edge of the second vibration plate 322 is connected to the inner edge of the diaphragm 34. The inner fixing portion 362 is connected to the second vibration plate 322 and the voice coil 33, and is electrically connected to the lead wire of the voice coil 33.

In this embodiment, as shown in FIG. 3 to FIG. 12, the centering sheet 36 serves two purposes: firstly, it makes the voice coil 33 connected to the external circuit through the centering sheet 36; secondly, the centering sheet 36 centers the vibration of the voice coil 33, through the rigid connector 35, preventing the voice coil 33 from swaying or polarizing during vibration.

To avoid interference or influence from the centering sheet 36 on the second diaphragm assembly 32, the folded ring portion 321 of the second diaphragm assembly 32 protrudes towards the direction close to the first diaphragm assembly 31. It can be understood that there can be one or more centering sheets 36. When there are multiple centering sheets 36, multiple centering sheets 36 are distributed along the long axis and/or the short axis of the magnetic circuit system 2 and/or at the four corners of the magnetic circuit system 2.

The multiple centering sheets 36 can be symmetrically distributed along the long axis of the magnetic circuit system 2; the multiple centering sheets 36 can also be symmetrically distributed along the short axis of the magnetic circuit system 2; the multiple centering sheets 36 can also be correspondingly provided at the four corners of the magnetic circuit system 2. In other embodiments, the multiple centering sheets 36 can be distributed along the long axis of the magnetic circuit system 2, or the short axis of the magnetic circuit system 2, or diagonally or at the four corners of the magnetic circuit system 2, which is not limited here.

In an embodiment, two or four centering sheets 36 may be provided. This arrangement allows the voice coil 33 to be connected to an external circuit through the centering sheet 36, while also ensuring the vibration balance of the sound-generating device 100.

In an embodiment, the centering sheet 36 includes an outer fixing portion 361, an inner fixing portion 362, and a vibration arm 363 connecting the outer fixing portion 361 and the inner fixing portion 362. The outer fixing portion 361 is connected to the housing 1, and the rigid connector 35 is provided at the inner fixing portion 362.

In this embodiment, as shown in FIG. 3 and FIG. 7 to FIG. 12, the inner fixing portion 362 is connected to the second vibration plate 322 of the second diaphragm assembly 32 and the voice coil 33, and is electrically connected to the lead wire of the voice coil 33. In an embodiment, the fixing portion 362 is provided with an inner bonding pad 3623, and the lead wire of the voice coil 33 is connected to the inner bonding pad 3623 for conductivity. This facilitates the routing and connection of the lead wire of the voice coil 33 and enables smooth connection and conductivity of the lead wire of the voice coil 33 with external circuitry.

In an embodiment, the rigid connector 35 is provided at the side of the fixing portion 362 away from the second diaphragm assembly 32. It can be understood that, this increases the distance between the centering sheet 36 and the magnetic circuit system 2. Only a part of the magnetic circuit system 2 is needed to avoid the rigid connector 35; no additional increase in the height of the sound-generating device 100 is required to meet the amplitude of the vibration system 3, thereby facilitating a thinner design.

In an embodiment, as shown in FIG. 3 and FIG. 8 to FIG. 12, the outer fixing portion 361, the vibration arm 363, and the inner fixing portion 362 of the centering sheet 36 can be integrally formed. This effectively ensures the structural strength of the centering sheet 36 and simplifies processing steps. To ensure the deformation capability of the centering sheet 36, the vibration arm 363 may have at least one bend.

In an embodiment, as shown in FIG. 3 and FIG. 8 to FIG. 12, the outer fixing portion 361 is in an annular shape, and is provided with a short axis side and a long axis side. The vibration arm 363 extends from the inner fixing portion 362 corresponding to the short axis side and extends along the long axis side after bending. The vibration arm 363 is connected to the central region of the long axis side.

In this embodiment, as shown in FIG. 3 and FIG. 8 to FIG. 12, there is one centering sheet 36. The outer fixing portion 361 of the centering sheet 36 can be a rectangular ring structure. There are at least two vibration arms 363 and four inner fixing portions 362. This arrangement increases the length of the vibration arms 363 and improves their stress, thereby improving reliability.

In an embodiment, there are four vibration arms 363 and four inner fixing portions 362. Each inner fixing portion 362 is connected to the outer fixing portion 361 through a vibration arm 363. In an embodiment, the four vibration arms 363 and four inner fixing portions 362 are provided at the four corners of the outer fixing portion 361 of the rectangular ring. In this embodiment, the four inner fixing portions 362 are respectively disposed corresponding to the avoidance space 233 of the side magnetic portion 23. At least a part of the inner fixing portions 362 extends through the avoidance space 233 into the magnetic gap 24 and is connected to the voice coil 33, which is not limited here.

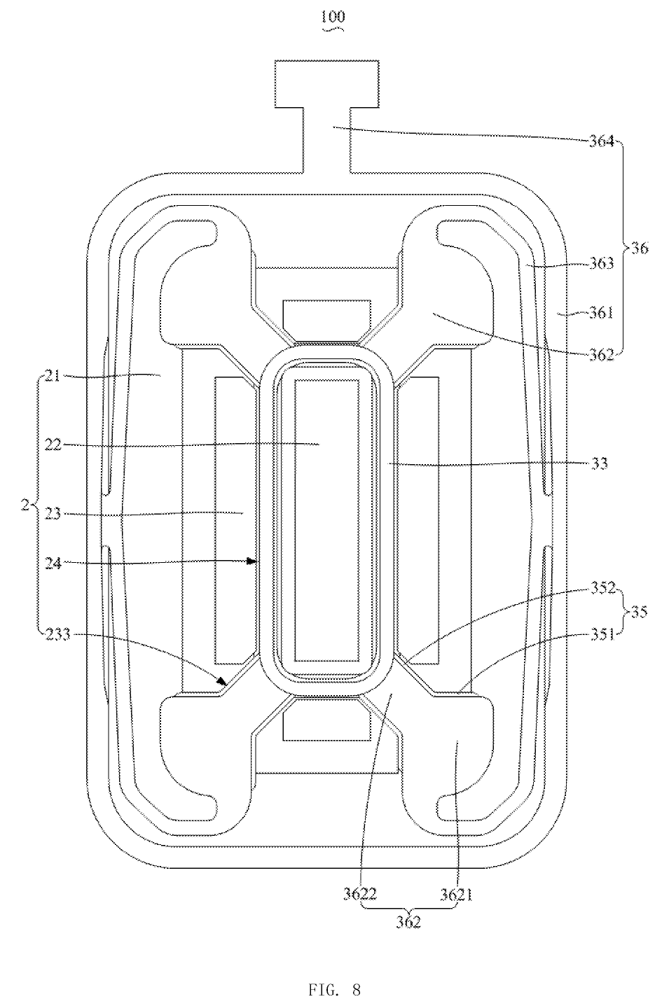

It is understood that, as shown in FIG. 3, FIG. 8 to FIG. 12, the outer fixing portion 361, the vibration arm 363, and the inner fixing portions 362 of the centering sheet 36 may be located on the same plane. In other embodiments, the outer fixing portion 361 and the inner fixing portion 362 of the centering sheet 36 may also be located on different planes, which is not limited here.

In this embodiment, as shown in FIG. 3, FIG. 7, and FIG. 8, the voice coil 33 may be in a rectangular shape. The four inner fixing portions 362 of the centering sheet 36 are respectively provided at the four corners of the voice coil 33, which are not limited here. The outer fixing portion 361 of the centering sheet 36 is bonded to the housing 1. The inner fixing portions 362 can be bonded to, welded to, or integrally formed with the rigid connector 35, which are not limited here. In this way, the length of the vibration arm 363 of the centering sheet 36 can be increased by utilizing the overall length of the product, resulting in better reliability during large amplitude operation. In addition, the centering sheet 36 provides limitation on the vibration system 3, thereby better avoiding performance degradation caused by product polarization under large amplitude.

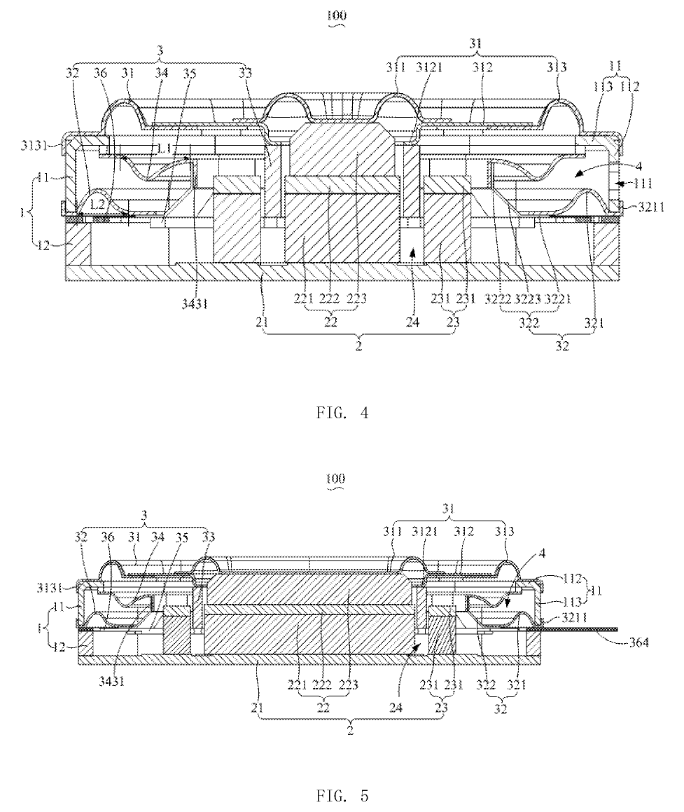

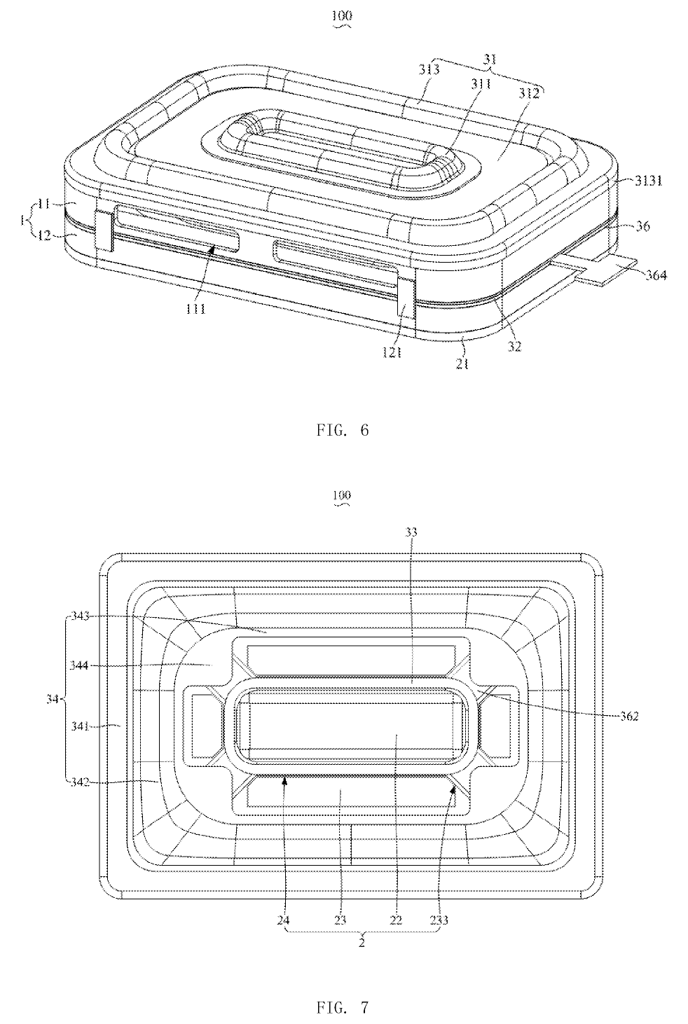

For better connection with external circuitry, in an embodiment, as shown in FIG. 1 to FIG. 3, FIG. 5, FIG. 6, and FIG. 8 to FIG. 12, the centering sheet 36 further includes a conductive portion 364. One end of the conductive portion 364 is connected to the external fixing portion 361. The other end of the conductive portion 364 extends away from the housing 1 and is provided with an external bonding pad 365. In this way, the external bonding pad 365 can be guided to the outside of the housing 1 through the conductive portion 364, thereby facilitating the connection and conduction between the external circuit and the centering sheet 36, ensuring that the current can flow through the voice coil 33.

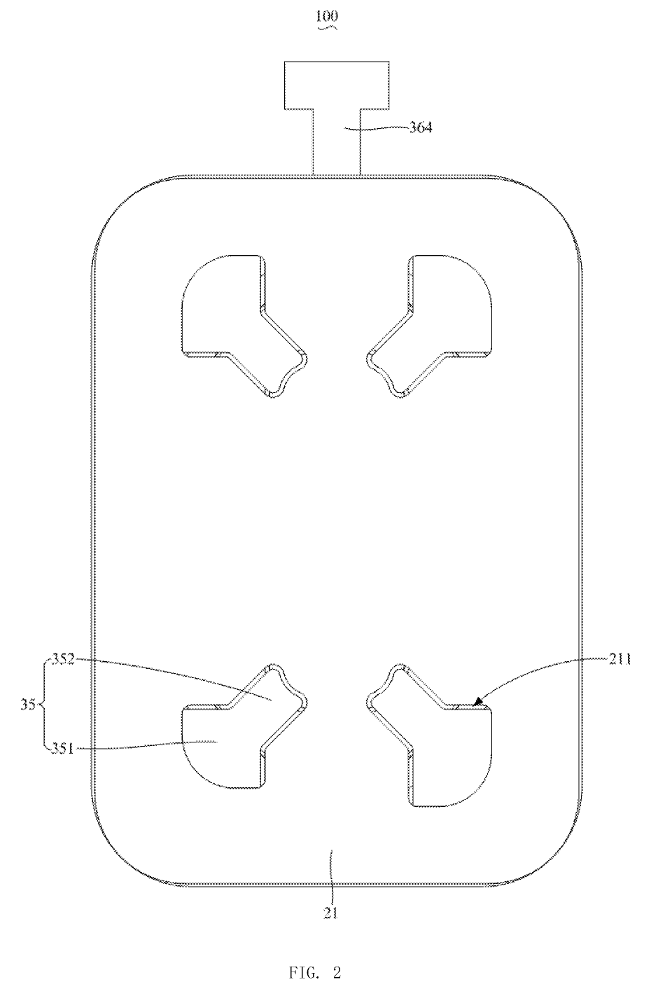

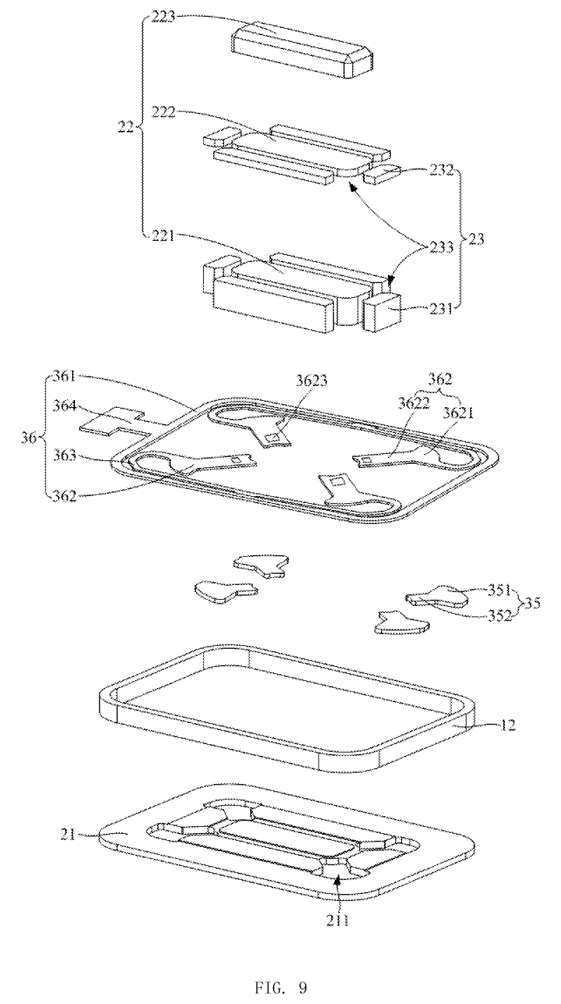

In an embodiment, the magnetic conductive yoke 21 is provided with an avoidance structure 211 corresponding to the internal fixing portion 362. As shown in FIG. 2, FIG. 3, and FIG. 9, by setting an avoidance structure 211 at the magnetic conductive yoke 21, the avoidance structure 211 can be utilized to provide avoidance space for the centering sheet 36 when the centering sheet 36 vibrates with the second diaphragm assembly 32, ensuring that the inner fixing portion 362 of the centering sheet 36 or the rigid connector 35 does not contact the magnetic conductive yoke 21.

In an embodiment, the avoidance structure 211 is a recessed groove or a through hole. The avoidance structure 211 is a recessed groove. That is, a groove structure is formed by the magnetic conductive yoke 21 being recessed on the side facing the centering sheet 36 in a direction away from the centering sheet 36. The avoidance structure 211 is a through hole, meaning the through hole passes through the magnetic conductive yoke 21. In addition, the avoidance structure 211 can also serve as a vent for the sound-generating device 100, ensuring that the airflow within the vibration cavity of the sound-generating device 100 can communicate with the external airflow during vibration of the first diaphragm assembly 31, thereby ensuring internal and external air pressure balance.

In an embodiment, the fixing portion 362 includes a body portion 3621 and a third extension portion 3622 extending from the body portion 3621 toward the voice coil 33. The body portion 3621 is connected to the second vibration plate 322, and the third extension portion 3622 is connected to the voice coil 33. The third extension portion 3622 or the body portion 3621 is provided with an inner bonding pad 3623 electrically connected to the lead wire of the voice coil 33.

In this embodiment, as shown in FIG. 3 and FIG. 8 to FIG. 12, the inner fixing portion 362 of the centering sheet 36 includes a body portion 3621 and a third extension portion 3622, with the third extension portion 3622 extending towards the voice coil 33. Thus, when the body portion 3621 of the inner fixing portion 362 is connected to the second vibration plate 322 of the second diaphragm assembly 32, the inner fixing portion 362 of the centering sheet 36 is connected to the voice coil 33 through the third extension portion 3622, which further ensures that the voice coil 33 drives the second diaphragm assembly 32 to vibrate during vibration.

It can be understood that, by providing an inner bonding pad 3623 at the third extension portion 3622 or the body portion 3621, it is convenient to connect the inner bonding pad 3623 to the lead wire of the voice coil 33, thus ensuring that the voice coil 33 is connected to the external circuit through the centering sheet 36.

In an embodiment, the rigid connector 35 includes a rigid connecting portion 351 and a fourth extension portion 352 extending from the rigid connecting portion 351 toward the voice coil 33. The rigid connecting portion 351 is connected to the body portion 3621, and the fourth extension portion 352 is correspondingly connected to the third extension portion 3622.

In this embodiment, as shown in FIG. 3 and FIG. 8 to FIG. 12, the rigid connector 35 includes a rigid connecting portion 351 and a fourth extension portion 352. In this way, the rigid connector 35 can be connected to the fixing portion 362 of the centering sheet 36 through the rigid connecting portion 351, and can be connected to the voice coil 33 through the fourth extension portion 352. This ensures the connection strength between the voice coil 33 and the second diaphragm assembly 32 through the the rigid connector 35, further ensuring that the voice coil 33 drives the second diaphragm assembly 32 to vibrate during vibration.

In an embodiment, the housing 1 includes a first housing 11 and a second housing 12. The first housing 11 is provided with a sound hole 111. The outer periphery of the outer folded ring 313 and the outer periphery of the diaphragm 34 are both connected to the first housing 11. The magnetic conductive yoke 21 is connected to the second housing 12. The outer periphery of the second diaphragm assembly 32 is clamped between the first housing 11 and the second housing 12.

In this embodiment, as shown in FIG. 3 to FIG. 6 and FIG. 9, the housing 1 includes a first housing 11 and a second housing 12; the first housing 11 is used to fix the first diaphragm assembly 31 to the outer periphery of the diaphragm 34; the second housing 12 is used to fix the magnetic circuit system 2. In addition, the first and second housings 11 and 12 are used to fix the outer periphery of the second diaphragm assembly 32.

It can be understood that, the outer periphery of the outer folded ring 313 of the first diaphragm assembly 31 and the outer periphery of the diaphragm 34 are both connected to the first housing 11; the magnetic conductive yoke 21 is connected to the second housing 12, and the outer periphery of the second diaphragm assembly 32 is clamped between the first housing 11 and the second housing 12.

In an embodiment, as shown in FIG. 3 to FIG. 12, the vibration system 3 further includes a centering sheet 36. The centering sheet 36 includes an outer fixing portion 361, an inner fixing portion 362, and a vibration arm 363 connecting the outer fixing portion 361 and the inner fixing portion 362. The outer fixing portion 361 is clamped between the second housing 12 and the outer periphery of the second diaphragm assembly 32. A rigid connector 35 is provided at the inner fixing portion 362; the inner fixing portion 362 is connected to the voice coil 33 and is electrically connected to the lead wire of the voice coil 33.

In this embodiment, the housing 1 can be a plastic housing or a metal housing; that is, both the first housing 11 and the second housing 12 can be either plastic or metal housings. In other embodiments, one of the first housing 11 and the second housing 12 may be a plastic housing, and the other of the first housing 11 and the second housing 12 may be a metal housing, and the like, which is not limited here.

In an embodiment, the second housing 12 and the magnetic conductive yoke 21 are integrally molded. It is understood that when the second housing 12 is a plastic housing, the second housing 12 and the magnetic conductive yoke 21 are integrally injection molded; when the second housing 12 is a metal housing, the second housing 12 and the magnetic conductive yoke 21 are integrally molded, which is not limited here.

In an embodiment, the first housing 11 may be a metal housing, and the second housing 12 may be a metal housing.

To further improve the connection stability between the first housing 11 and the second housing 12 or the magnetic conductive yoke 21, in an embodiment, as shown in FIG. 6, the first housing 11 is provided with a welding portion 121 extending toward the magnetic conductive yoke 21, and the welding portion 121 is welded to the magnetic conductive yoke 21 or the second housing 12. In another embodiment, as shown in FIG. 6, the magnetic conductive yoke 21 or the second housing 12 is provided with a welding portion 121 extending toward the first housing 11, and the welding portion 121 is welded to the outer wall of the first housing 11.

In another embodiment, the sound-generating device 100 further includes a metal welding sheet. One end of the metal welding sheet is welded to the magnetic conductive yoke 21 or the second housing 12. The other end of the metal welding sheet is welded to the outer wall of the first housing 11. This metal welding sheet further improves the connection stability between the first housing 11 and the second housing 12 or the magnetic conductive yoke 21.

In an embodiment, the first housing 11 is provided with a sidewall 112 and an inner bending portion 113; the end of the sidewall 112 away from the second housing 12 bends and extends inward to form the inner bending portion 113. The outer folded ring 313 and the outer periphery of the diaphragm 34 are connected to the inner bending portion 113. The outer periphery of the second diaphragm assembly 32 is clamped between the end of the sidewall 112 away from the inner bending portion 113 and the second housing 12; the sound hole 111 is provided at the sidewall 112 or the inner bending portion 113.

In this embodiment, as shown in FIG. 3 to FIG. 5, the first housing 11 includes a sidewall 112 and an inner bending portion 113, and an angel is formed between the sidewall 112 and the inner bending portion 113. The inner bending portion 113 of the first housing 11 is used to install and fix the first diaphragm assembly 31 and the diaphragm 34. In addition, the sidewall 112 of the first housing 11 cooperates with the second housing 12 to clamp and fix the outer periphery of the second diaphragm assembly 32 and the centering sheet 36. That is, the outer periphery of the folded ring portion 321 of the second diaphragm assembly 32 and the outer fixing portion 361 of the centering sheet 36 are clamped between the end of the sidewall 112 away from the inner bending portion 113 and the second housing 12.

Understandably, the outer fixing portion 361 of the centering sheet 36 is located between the outer periphery of the folded ring portion 321 of the second diaphragm assembly 32 and the second housing 12. The other end of the second housing 12 is connected to the magnetic conductive yoke 21. In this embodiment, the end of the sidewall 112 away from the second housing 12 bends and extends inward to form the inner bending portion 113 of the first housing 11. That is, the inner bending portion 113 and the sidewall 112 of the first housing 11 are integrally formed, ensuring the structural strength of the first housing 11, which is not limited here.

To further increase the contact area between the first diaphragm assembly 31 and the first housing 11 and improve connection stability and waterproof sealing, the outer periphery of the outer folded ring 313 of the first diaphragm assembly 31 is bent and extended to form a third flange 3131. The third flange 3131 is connected to the outer wall surface of the sidewall 112 of the first housing 11.

In this embodiment, the outer folded ring 313 of the first diaphragm assembly 31 is fixed to the inner bending portion 113 of the first housing 11, so that the first diaphragm assembly 31 is bonded and fixed to the maximum outer shape of the housing 1. This utilizes the product external sizes to increase the effective vibration area. Besides, the magnetic conductive yoke 21 of the magnetic circuit system 2 is fixed to the second housing 12, and the outer periphery of the second diaphragm assembly 32 is clamped between the first housing 11 and the second housing 12. The height of the housing 1 can be adjusted to increase or decrease according to the product amplitude requirements, thereby allowing the sound-generating cavity 4 between the diaphragm 34 and the second diaphragm assembly 32 to adapt to the needs of different products. The sound hole 111 is provided at the sidewall 112 or the inner bending portion 113, which is not limited here.

In an embodiment, as shown in FIG. 4 and FIG. 5, the inner bending portion 113 includes an upper surface, a lower surface, and an inner surface. The upper and lower surfaces are arranged opposite to each other; the inner surface connects the upper surface to the lower surface, and is located at the end of the inner bending portion 113 away from the sidewall 112.

In this embodiment, as shown in FIG. 4 and FIG. 5, the outer periphery of the outer folded ring 313 is connected to the upper surface, and the outer periphery of the diaphragm 34 is connected to the lower surface. This arrangement not only ensures the connection between the first diaphragm assembly 31 and the diaphragm 34, but also ensures a safe distance between the first diaphragm assembly 31 and the diaphragm 34, thus avoiding interference during vibration.

In other embodiments, the outer periphery of the outer folded ring 313 of the first diaphragm assembly 31 is connected to the upper surface, and the outer periphery of the diaphragm 34 is connected to the inner surface; or, the outer periphery of the outer folded ring 313 is connected to the upper surface, and the outer periphery of the diaphragm 34 is clamped between the outer periphery of the outer folded ring 313 and the upper surface; or, the outer periphery of the outer folded ring 313 is connected to the inner surface, and the outer periphery of the diaphragm 34 is connected to the lower surface; or, both the outer folded ring 313 and the outer periphery of the diaphragm 34 are connected to the inner surface, which is not limited here.

It is understood that the outer connecting portion 341 of the diaphragm 34 can be connected to the lower surface, the inner surface, or the upper surface of the inner bending portion 113, and the like, which is not limited here. In this embodiment, when both the outer connecting portion 341 of the diaphragm 34 and the outer periphery of the outer folded ring 313 are connected to the upper surface of the inner bending portion 113, the outer connecting portion 341 of the diaphragm 34 is located between the outer periphery of the outer folded ring 313 and the upper surface of the inner bending portion 113, which is not limited here.

In an embodiment, the central magnetic portion 22 includes a first central magnet 221, a central magnetic conductive plate 222, and a second central magnet 223 stacked together. The first central magnet 221 is connected to the magnetic conductive yoke 21, and the inner side of the inner folded ring 311 is connected to the second central magnet 223.

In this embodiment, as shown in FIG. 3 to FIG. 5 and FIG. 9, by setting the central magnetic portion 22 as a magnetic-opposite structure, the first central magnet 221, the central magnetic conductive plate 222 and the second central magnet 223 are sequentially stacked at the magnetic conductive yoke 21 in the vertical direction. Understandably, both the first central magnet 221 and the second central magnet 223 are magnetized along the vibration direction of the vibration system 3. Furthermore, the magnetization direction of the first central magnet 221 is opposite to the magnetization direction of the second central magnet 223. Thus, utilizing the magnetic conductivity of the central magnetic conductive plate 222, the magnetic field lines of the first central magnet 221 and the second central magnet 223 are concentrated on the central magnetic conductive plate 222, and the central magnetic conductive plate 222 will transmit the magnetic field lines to the magnetic gap 24, so that the central magnetic portion 22 can generate a strong magnetic field that passes through the magnetic gap 24, which not only increases the magnetic flux density of the magnetic gap 24 and increases the number of magnetic field lines passing through the voice coil 33, but also increases the magnetic force on the voice coil 33, thereby effectively improving the BL value.

In an embodiment, the whole first central magnet 221 is a plate-shaped structure. In an embodiment, as shown in FIG. 3 to FIG. 5 and FIG. 9, by setting the first central magnet 221 as a plate-shaped structure, it is easier to process, assemble, and magnetize the first central magnet 221, effectively improving production and assembly efficiency.

In other embodiments, there are multiple first central magnets 221, which are adjacent and provided between the central magnetic conductive plate 222 and the magnetic conductive yoke 21. The multiple central magnets 221 are magnetized along the vibration direction of the vibration system 3, and their magnetization directions are the same. In an embodiment, the magnetic poles of the multiple central magnets 221 near the central magnetic conductive plate 222 are the same.

In an embodiment, the central magnetic conductive plate 222 of the central magnetic portion 22 can be an integral square plate structure provided between the first central magnet 221 and the second central magnet 223; or, multiple central magnetic conductive plates 222 may be provided, and the multiple central magnetic conductive plates 222 are arranged adjacently and in parallel between the first central magnet 221 and the second central magnet 223, so that the multiple central magnetic conductive plates 222 cooperate to form a square plate structure, which is not limited here.

In an embodiment, the whole second central magnet 223 is a plate-shaped structure. In an embodiment, as shown in FIG. 3 to FIG. 5 and FIG. 9, by setting the second central magnet 223 as a plate-shaped structure, it is easier to process, assemble, and magnetize the second central magnet 223, effectively improving production and assembly efficiency.

In other embodiments, there are multiple second central magnets 223 that are adjacent and laid flat on the side of the central magnetic conductive plate 222 away from the first central magnet 221. The multiple second central magnets 223 are magnetized along the vibration direction of the vibration system 3, and their magnetization directions are the same. In an embodiment, the magnetic poles of the multiple second central magnets 223 near the central magnetic conductive plate 222 are the same.

In this embodiment, the inner side of the inner folded ring 311 of the first diaphragm assembly 31 is connected to the inner central magnet 223. To prevent the second central magnet 223 from interfering with the inner folded ring 311 when the inner folded ring 311 vibrates, in an embodiment, as shown in FIG. 4 and 5, an avoidance structure is provided at the edge of the second central magnet 223.

In this embodiment, the avoidance structure surrounds the periphery of the second central magnet 223 on the side away from the central magnetic conductive plate 222. That is, the avoidance structure is an integral annular inclined surface. In other embodiments, there are multiple avoidance structures distributed at intervals, and surround the periphery of the second central magnet 223 on the side away from the central magnetic conductive plate 222. In this case, adjacent avoidance structures are not connected to each other and have a certain distance between them. There are multiple avoidance structures, with adjacent avoidance structures connected end-to-end to form a closed ring structure, and the closed ring structure surrounds the periphery of the side of the second central magnet 223 away from the central magnetic conductive plate 222. In this case, adjacent avoidance structures form a ring structure. In an embodiment, the angles formed between the multiple avoidance structures and the surface of the side of the second central magnet 223 away from the central magnetic conductive plate 222 may be the same, or may be different, or at least partially the same, which is not limited here.

In an embodiment, the avoidance structure may include at least one of an inclined slope, a rounded corner, a chamfer, or a stepped structure.

In an embodiment, the angle formed between the avoidance structure and the surface of the side of the second central magnet 223 away from the central magnetic conductive plate 222 is greater than 90° and less than 180°. In this embodiment, the angle formed by the avoidance structure and the surface of the side of the second central magnet 223 away from the central magnetic conductive plate 222 can be further ranged from 100° to 150°, which is not limited here. In an embodiment, the angle can be 100°, 110°, 120°, 130°, 140°, 150°, and the like, which is not limited here.

In an embodiment, the side magnetic portion 23 includes a side magnet 231 and a side magnetic conductive plate 232 stacked together. The side magnet 231 is connected to the magnetic conductive yoke 21. The side magnetic conductive plate 232 is disposed opposite to the central magnetic conductive plate 222. The side magnet 231 is magnetized along the vibration direction of the vibration system 3, and the magnetization direction of the side magnet 231 is opposite to the magnetization direction of the first central magnet 221.

As can be understood, as shown in FIG. 3 to FIG. 5 and FIG. 9, the side magnet 231 and the side magnetic conductive plate 232 of the side magnetic portion 23 are stacked at the magnetic conductive yoke 21, and the side magnet 231 is connected to the magnetic conductive yoke 21. The side magnet 231 and the side magnetic conductive plate 232 of the side magnetic portion 23 are located outside the central magnetic portion 22 and are spaced apart to form a magnetic gap 24. In this embodiment, the side magnet 231 may be a permanent magnet, and the side magnetic conductive plate 232 may be a magnetic conductive plate structure, which is not limited here.

In this embodiment, there are multiple side magnetic portions 23 arranged around the outside of the central magnetic portion 22 and spaced apart from the central magnetic portion 22 to form a magnetic gap 24. In this case, an avoidance space 233 is formed between adjacent side magnetic portions 23, thus providing an avoidance space and a movement space for the rigid connector 35 and the inner fixing portion 362 of the centering sheet. In an embodiment, multiple side magnets 231 and side magnetic conductive plates 232 are provided, and a side magnet 231 is provided corresponding to a side magnetic conductive plate 232.

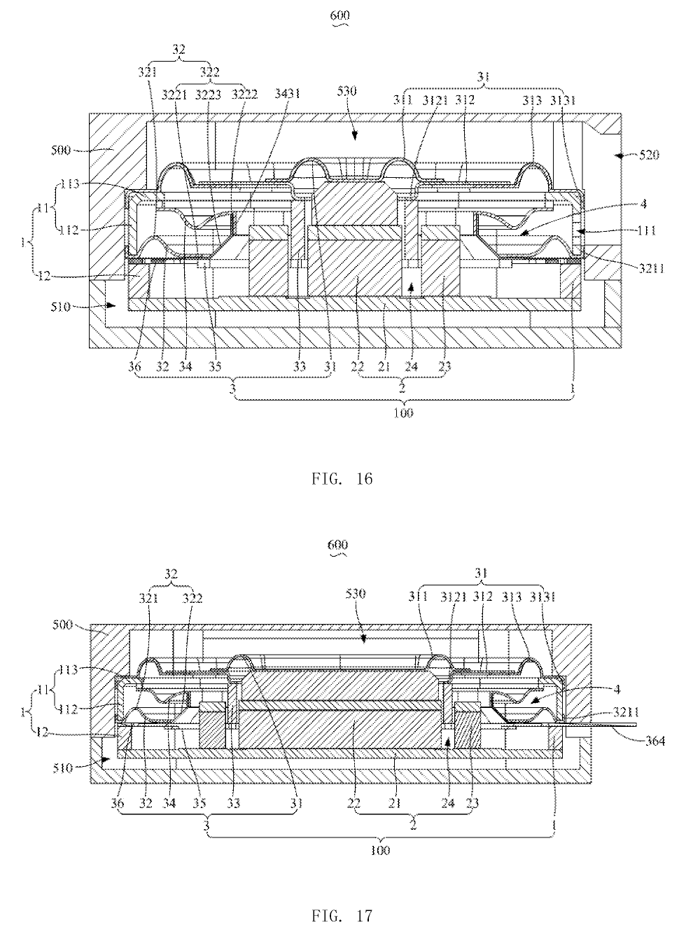

As shown in FIG. 16 and FIG. 17, the present application further proposes a sound-generating module 600, which includes the aforementioned sound-generating device 100. The specific structure of the sound-generating device 100 is as described in the foregoing embodiments. Since this sound-generating module 600 adopts all the technical solutions of all the foregoing embodiments, it possesses at least all the beneficial effects brought about by the technical solutions of the foregoing embodiments, which will not be repeated here.

In an embodiment, the sound-generating module 600 further includes a module housing 500, which is provided with a mounting cavity 510 and a sound outlet 520 communicating with the mounting cavity 510. The sound-generating device 100 is provided in the mounting cavity 510. A front acoustic cavity 530 is formed between the first diaphragm assembly 31 of the sound-generating device 100 and the module housing 500, and the front acoustic cavity 530 communicates with the sound outlet 520. The sound-generating cavity 4 of the sound-generating device 100 communicates with the sound outlet 520 through the front acoustic cavity 530. The module housing 500 may also have a sound channel, and the sound-generating cavity 4 of the sound-generating device 100 communicates with the sound outlet 520 through a sound channel; or, the sound hole 111 of the sound-generating device 100 directly communicates with the sound outlet 520.

In this embodiment, the sound-generating module 600 can be a front-emitting structure or a side-emitting structure. When the sound-generating module 600 is a front-emitting structure, a sound outlet 520 of the module housing 500 is provided opposite to the first diaphragm assembly 31 of the sound-generating device 100. It can be understood that, the sound hole 111 on the housing 1 of the sound-generating device 100 is located on the inner bending portion 113 of the first housing 11, and the sound hole 111 is disposed directly opposite the sound outlet 520 of the module housing 500. In this case, the sound hole 111 communicates with the front acoustic cavity 530; or, the sound hole 111 communicates with the sound outlet 520 through the sound channel of the module housing 500, which is not limited here.

The sound hole 111 on the housing 1 can also be located on the sidewall 112 of the first housing 11, and the sound hole 111 communicates with the sound outlet 520 through the sound channel of the module housing 500, which is not limited here.

It can be understood that, when the sound-generating module 600 is a side-emitting structure, the sound outlet 520 of the module housing 500 is located at one side of the first diaphragm assembly 31 of the sound-generating device 100. It can be understood that, the sound hole 111 on the housing 1 of the sound-generating device 100 is located at the inner bending portion 113 of the housing 11. In this case, the sound hole 111 can communicate with the sound outlet 520 through the sound channel of the module housing 500, which is not limited here.

The sound hole 111 on the housing 1 can also be located at the sidewall 112 of the first housing 11. In this case, the sound hole 111 communicates with the sound outlet 520 through the sound channel of the module housing 500; or, the sound hole 111 is disposed opposite to the sound outlet 520 of the module housing 500, and the sound hole 111 directly communicates with the sound outlet 520, which is not limited here.

In an embodiment, the sound-generating module 600 further includes a flexible circuit board. One end of the flexible circuit board is electrically connected to the centering sheet 36 of the sound-generating device 100, and the other end of the flexible circuit board is connected to an external power supply.

The flexible circuit board is used to connect and conduct the external circuit to the sound-generating device 100. The flexible circuit board is provided with an inner bonding pad and an outer bonding pad. The inner bonding pad of the flexible circuit board is connected and conductive to the outer bonding pad 365 of the centering sheet 36 of the sound-generating device 100. The outer bonding pad of the flexible circuit board is connected to external terminals.

In this embodiment, the module housing 500 is provided with a mounting cavity 510. The sound-generating device 100 is provided inside the mounting cavity 510 of the module housing 500. At least one end of the flexible circuit board connected to the sound-generating device 100 is provided inside the mounting cavity 510 of the module housing 500. In other embodiments, the entire flexible circuit board may be provided inside the mounting cavity 510 of the module housing 500, which is not limited here.

The present application further proposes an electronic device, which includes the aforementioned sound-generating device 100. The specific structure of the sound-generating device 100 is as described in the foregoing embodiments. Since this electronic device adopts all the technical solutions of all the foregoing embodiments, it possesses at least all the beneficial effects brought about by the technical solutions of the foregoing embodiments, which will not be repeated here.

In this embodiment, the electronic device further includes a housing. The sound-generating device 100 and the flexible circuit board are both provided within the housing. The electronic device can be headphones, mobile phones, smart wearable devices, and the like, which is not limited here.

The present application further proposes an electronic device including the aforementioned sound-generating module 600. The specific structure of the sound-generating module 600 is as described in the foregoing embodiments. Since this electronic device adopts all the technical solutions of all the foregoing embodiments, it possesses at least all the beneficial effects brought about by the technical solutions of the foregoing embodiments, and will not be elaborated further here.

The electronic device can be headphones, mobile phones, smart wearable devices, and the like, which is not limited here. In this embodiment, the electronic device further includes a housing, and the sound-generating module 600 is provided within the housing.

The above are only some embodiments of the present application, and do not limit the scope of the present application thereto. Under the concept of the present application, any equivalent structural transformation made according to the description and drawings of the present application, or direct/indirect applied in other related technical fields shall fall within the claimed scope of the present application.

1. A sound-generating device, comprising:
a housing, provided with a sound hole;
a magnetic circuit system, connected to the housing, wherein the magnetic circuit system comprises a magnetic conductive yoke, a central magnetic portion, and a side magnetic portion; the central magnetic portion and the side magnetic portion are provided at the magnetic conductive yoke; the side magnetic portion is provided outside the central magnetic portion and forms a magnetic gap with the central magnetic portion; the central magnetic portion comprises a first central magnet, a central magnetic conductive plate, and a second central magnet distributed in a stacked manner; the first central magnet is connected to the magnetic conductive yoke; and
a vibration system, comprising a first diaphragm assembly, a second diaphragm assembly, a voice coil, a diaphragm, and a rigid connector; wherein the first diaphragm assembly comprises an inner folded ring, a first vibration plate, and an outer folded ring connected in sequence; an inner side of the inner folded ring is connected to a second central magnet; an outer periphery of the outer folded ring is connected to the housing; an end of the voice coil is connected to the first diaphragm assembly; the other end of the voice coil is suspended in the magnetic gap; the diaphragm and the second diaphragm assembly are sequentially provided at a side of the first diaphragm assembly facing the magnetic conductive yoke, and are provided outside the voice coil; an outer edge of the diaphragm is connected to the housing, and an outer edge of the second diaphragm assembly is connected to the housing; an inner edge of the diaphragm is connected to an inner edge of the second diaphragm assembly to form a sound-generating cavity communicating with the sound hole between the diaphragm and the second diaphragm assembly; an end of the rigid connector is connected to the second diaphragm assembly; the other end of the rigid connector is connected to the voice coil, to make the voice coil drive the second diaphragm assembly to vibrate through the rigid connector;
both the first central magnet and the second central magnet are magnetized along a vibration direction of the vibration system, and a magnetization direction of the first central magnet is opposite to a magnetization direction of the second central magnet.

2. The sound-generating device according to claim 1, wherein the second diaphragm assembly comprises a folded ring portion and a second vibration plate; an outer periphery of the folded ring portion is connected to the housing; the second vibration plate comprises a main body portion connected to an inner edge of the folded ring portion and a first bending portion; the first bending portion is formed by the main body portion bending and extending toward the diaphragm; the first bending portion is connected to the inner edge of the diaphragm.

3. The sound-generating device according to claim 2, wherein an inclined portion is formed at a joint between the main body portion and the first bending portion; an angle is formed between the inclined portion and the vibration direction of the vibration system; and/or
the outer periphery of the folded ring portion is bent to form a first flange; the first flange is connected to an outer wall of the housing.

4. The sound-generating device according to claim 2, wherein:
a plurality of side magnetic portions are provided; an avoidance space is formed between two adjacent side magnetic portions; the second vibration plate is provided with a first extension portion extending to the avoidance space; the diaphragm is provided with a second extension portion extending to the avoidance space; the second extension portion is connected to the first extension portion; or
a plurality of side magnetic portions are provided; an avoidance space is formed between two adjacent side magnetic portions; the voice coil is provided with a first protrusion portion extending to the avoidance space; the central magnetic portion is provided with a second protrusion portion extending into the avoidance space; the first protrusion portion is disposed opposite to the second protrusion portion.

5. The sound-generating device according to claim 2, wherein the diaphragm is a flexible component; the diaphragm comprises an outer connecting portion, a deformable portion, and an inner connecting portion connected in sequence; an outer periphery of the outer connecting portion is connected to the housing; an inner edge of the inner connecting portion is connected to the first bending portion, and the deformable portion is in a bent shape.

6. The sound-generating device according to claim 5, wherein:
the inner edge of the inner connecting portion is configured to bend and extend toward the first bending portion to form a second flange, and the second flange is connected to the first bending portion; and/or
along the vibration direction of the vibration system, a projection width L1 of the deformable portion is greater than or equal to a projection width L2 of the folded ring portion, and a ratio of L1 to L2 is ranged from 1:1 to 3:1; and/or
the deformable portion is configured to protrude toward a direction away from the first diaphragm assembly; the folded ring portion is configured to protrude toward a direction close to the first diaphragm assembly; the deformable portion and the folded ring portion are staggered along a direction perpendicular to the vibration system; and/or
both the inner folded ring and the outer folded ring are configured to protrude along a direction away from the magnetic circuit system; and/or
a compliance of the diaphragm is greater than a compliance of the folded ring portion.

7. The sound-generating device according to claim 1, wherein an effective vibration area Sd1 of the diaphragm is smaller than an effective vibration area Sd2 of the second diaphragm assembly, and a ratio of Sd1 to Sd2 is ranged form 1:1.5 to 1:3.

8. The sound-generating device according to claim 1, wherein the first vibration plate is configured to bend and extend toward the voice coil to form a second bending portion; the second bending portion is connected to the voice coil; or the first diaphragm assembly further comprises a bracket; an end of the bracket is connected to the first vibration plate, and the other end of the bracket is connected to the voice coil; and/or
the outer periphery of the outer folded ring is configured to bend and extend to form a third flange; the third flange is connected to an outer wall of the housing.

9. The sound-generating device according to claim 1, wherein:
the vibration system further comprises a centering sheet; the centering sheet comprises an outer fixing portion, an inner fixing portion, and a vibration arm connecting the outer fixing portion and the inner fixing portion; the outer fixing portion is connected to the housing, and the rigid connector is provided at the inner fixing portion;
the second diaphragm assembly comprises a folded ring portion and a second vibration plate connected to the folded ring portion; an outer periphery of the folded ring portion is connected to the housing; an inner edge of the second vibration plate is connected to an inner edge of diaphragm; and
the inner fixing portion is connected to the second vibration plate and the voice coil, and is electrically connected to a lead wire of the voice coil.

10. The sound-generating device according to claim 9, wherein the inner fixing portion comprises a body portion and a third extension portion extending from the body portion toward the voice coil; the body portion is connected to the second vibration plate, and the third extension portion is connected to the voice coil; the third extension portion or the body portion is provided with an inner bonding pad electrically connected to the lead wire of the voice coil.

11. The sound-generating device according to claim 10, wherein:
the magnetic conductive yoke is provided with an avoidance structure corresponding to the inner fixing portion; the avoidance structure is a recessed groove or a through hole; and/or
the rigid connector comprises a rigid connecting portion and a fourth extension portion extending from the rigid connecting portion toward the voice coil; the rigid connecting portion is connected to the body portion, and the fourth extension portion is connected to the third extension portion; and/or
the rigid connector is provided at a side of the inner fixing portion away from the second diaphragm assembly; and/or
the outer fixing portion is arranged in an annular shape; the outer fixing portion is provided with a short axis side and a long axis side connected to the short axis side in a staggered manner; the vibration arm is led out from a side of the inner fixing portion corresponding to the short axis side, and extends along the long axis side after being bent; the vibration arm is connected to a central region of the long axis side; and/or
the centering sheet further comprises a conductive portion; one end of the conductive portion is connected to the outer fixing portion; the other end of the conductive portion is configured to extend along a direction away from the housing and is provided with an external bonding pad.

12. The sound-generating device according to claim 1, wherein the housing comprises a first housing and a second housing; the first housing is provided with the sound hole; both the outer periphery of the outer folded ring and an outer periphery of the diaphragm are connected to the first housing; the magnetic conductive yoke is connected to the second housing; an outer periphery of the second diaphragm assembly is clamped between the first housing and the second housing.

13. The sound-generating device according to claim 12, wherein the first housing is provided with a sidewall and an inner bending portion; an end of the sidewall away from the second housing is configured to bend and extend inward to form the inner bending portion; both the outer folded ring and the outer periphery of the diaphragm are connected to the inner bending portion; the outer periphery of the second diaphragm assembly is clamped between an end of the sidewall away from the inner bending portion and the second housing; the sound hole is provided at the sidewall or the inner bending portion.

14. The sound-generating device according to claim 13, wherein the inner bending portion comprises an upper surface, a lower surface, and an inner surface; the upper surface and the lower surface are disposed opposite to each other; the inner surface is configured to connect the upper surface and the lower surface, and the inner surface is provided at an end of the inner bending portion away from the sidewall; and
the outer periphery of the outer folded ring is connected to the upper surface, and the outer periphery of the diaphragm is connected to the lower surface; or, the outer periphery of the outer folded ring is connected to the upper surface, and the outer periphery of the diaphragm is clamped between the outer periphery of the outer folded ring and the upper surface.

15. The sound-generating device according to claim 12, wherein the first housing is a metal housing, and the second housing is a metal housing;
the first housing is provided with a welding portion extending toward the magnetic conductive yoke, and the welding portion is welded to the magnetic conductive yoke or the second housing; and/or, the magnetic conductive yoke or the second housing is provided with a welding portion extending toward the first housing, and the welding portion is welded to an outer wall of the first housing; and/or, the sound-generating device further comprises a metal welding sheet, one end of the metal welding sheet being connected to the magnetic conductive yoke or the second housing; the other end of the metal welding sheet being welded to an outer wall of the first housing; and/or
the second housing and the magnetic conductive yoke are integrally formed; and/or
the vibration system further comprises a centering sheet; the centering sheet comprises an outer fixing portion, an inner fixing portion, and a vibration arm connecting the outer fixing portion and the inner fixing portion; the outer fixing portion is clamped between the second housing and the outer periphery of the second diaphragm assembly; the rigid connector is provided at the inner fixing portion; the inner fixing portion is connected to the voice coil and electrically connected to a lead wire of the voice coil.

16. The sound-generating device according to claim 1, wherein the side magnetic portion comprises a side magnet and a side magnetic conductive plate stacked together; the side magnet is connected to the magnetic conductive yoke; the side magnetic conductive plate is disposed opposite to the central magnetic conductive plate; a magnetization direction of the side magnet is opposite to a magnetization direction of the first central magnet.

17. A sound-generating module, comprising:
a module housing provided with a mounting cavity and a sound outlet communicating with the mounting cavity; and
the sound-generating device according to claim 1;
wherein:
the sound-generating device is provided in the mounting cavity; a front acoustic cavity is formed between the first diaphragm assembly of the sound-generating device and the module housing; the front acoustic cavity communicates with the sound outlet; and
the sound-generating cavity of the sound-generating device communicates with the sound outlet through the front acoustic cavity; or, the module housing is further provided with a sound channel, and the sound-generating cavity of the sound-generating device communicates with the sound outlet through the sound outlet channel; or, the sound outlet of the sound-generating device is directly opposite to and communicates with the sound outlet.

18. An electronic device, comprising: the sound-generating device according to claim 1.
